(19) United States
(12) Patent Application Publication
(10) Pub. No.: US 2013/0274144 A1
(43) Pub. Date: Oct. 17, 2013

(54) COMPOUNDS, REACTIONS, AND SCREENING METHODS

(71) Applicants: John F. HARTWIG, Berkeley, CA (US); Daniel W. ROBBINS, Boston, MA (US); Seth J. HERZON, New Haven, CT (US)

(72) Inventors: John F. HARTWIG, Berkeley, CA (US); Daniel W. ROBBINS, Boston, MA (US); Seth J. HERZON, New Haven, CT (US)

(73) Assignee: The Board of Trustees of the University of Illiois, Urbana, IL (US)

(21) Appl. No.: 13/598,470

(22) Filed: Aug. 29, 2012

Related U.S. Application Data
(60) Provisional application No. 61/528,565, filed on Aug. 29, 2011.

(51) Int. Cl. G01N 21/25

(52) U.S. Cl. CPC G01N 21/25
USPC 506/12; 564/271; 564/305; 585/437; 585/436

(57) ABSTRACT

The invention provides a method comprising identifying a successful metal-mediated conjugation reaction by analyzing a test mixture for the presence of a conjugation product. The invention provides a two-dimensional approach to reaction discovery in which many catalysts for many catalytic reactions can be tested simultaneously to provide an efficient discovery platform. Reactants and products from the system can be identified using techniques such as gas chromatography, liquid chromatography, mass spectrometry, and combinations thereof.

This application claims priority under 35 U.S.C. §119(e) to U.S. Provisional Patent Application No. 61/528,565, filed Aug. 29, 2012, which is incorporated herein by reference.

### GOVERNMENT SUPPORT

This invention was made with government support under contract number GM093540-01 awarded by the National Institutes of Health and contract number CHE-0910641 awarded by the National Science Foundation. The Government has certain rights in the invention.

### BACKGROUND OF THE INVENTION

Complexes of transition metals catalyze many important reactions used in medicine, materials science and energy production. The advent of combinatorial methods for the discovery of new drug candidates and new enzymes for organic synthesis has raised the prospect of applying analogous high-throughput experimental methods to the discovery of catalytic transformations. Many studies on this topic have been published over the past two decades. Although the experimental designs that have been reported all have merit, few have been used by laboratories beyond those disclosing the original studies. High-throughput methods for catalyst discovery that would mirror related approaches for the discovery of medicinally active compounds have been the focus of much attention over the past fifteen years. However, these methods have not been sufficiently general or accessible to synthetic laboratories to be adopted widely. Many of these reactions require cationic intermediates or acidic products, substrates with colorimetric tags, involve sequential optimization of portions of modular ligands, require the attachment of reactants to DNA fragments and amplification by PCR to identify the product, or involve robotic equipment having a cost that is prohibitory to most laboratories.

Thus, to apply combinatorial methods to catalyst discovery in a general fashion, new methods are needed that use equipment commonly available in a synthetic laboratory or obtainable at a comparable cost. Also needed are new catalytic transformations for use in synthetic chemistry, medicine, materials science and energy production.

### SUMMARY

The invention provides methods that include simple, multi-dimensional approaches to high-throughput discovery of metal-mediated reactions, including catalytic reactions. The invention also provides new catalytic reactions, for example, copper-catalyzed alkyne hydroamination reactions, and nickel-catalyzed hydroarylation reactions, that display excellent functional group tolerance.

Accordingly, the invention provides a method comprising identifying a successful metal-mediated conjugation reaction by analyzing a test mixture for the presence of a conjugation product. The test mixture can include a combination of several reaction mixtures. Prior to reaction initiation, each reaction mixture can include a metal catalyst precursor, a ligand, and a diverse mixture of substrates. One or more of the reaction mixtures can also serve as control reactions, where the control mixture lacks a metal catalyst precursor, lacks a ligand, or lacks both a metal catalyst precursor and a ligand, but otherwise includes each of the components of one or more of the reaction mixtures. The reaction mixtures can optionally include a solvent and/or one or more optional additives known to those of skill in the art. Examples of such additives include as an oxidant, a reductant, an acid, a base, and/or a small molecule additive such as carbon monoxide (CO), carbon dioxide (CO₂), and the like. Thus, multiple catalysts and reactants can be evaluated simultaneously.

One or more of the reaction mixtures, typically all, can be heated to initiate a potential metal-mediated conjugation reaction. Any conjugation product formed from a metal-mediated conjugation reaction would have a mass that would lie outside the range of masses of any of the reactants. For example, the reactions can be designed so that the mass of any conjugation product formed from a metal-mediated conjugation reaction will exceed the mass of any single substrate of the reaction mixtures, for example, by at least about 50%. The presence of a conjugation product in the test mixture confirms that a metal-mediated conjugation reaction occurred in one or more of the reaction mixtures.

In some embodiments, one or more of the reaction mixtures can exclude a ligand or metal catalyst precursor. In various embodiments, at least one conjugation product is present in the test mixture.

The invention further provides methods comprising identifying successful conditions for a metal-mediated reaction, methods comprising identifying one or more active reactions in an array of reactions, methods comprising identifying a conjugation reaction product in a mixture, methods comprising screening a wide range of metal-ligand combinations, for example, to determine combinations that are effective to mediate a metal-catalyzed reaction, and methods comprising identifying a metal catalyst precursor-ligand combination that initiates a conjugation reaction.

In another embodiment, the invention provides a method comprising identifying the occurrence of a conjugation reaction. The identification can be carried out by conducting an experiment on an x-y array of reaction vessels. Each reaction vessel can include, for example, at least four substrates having substantially similar masses, a metal catalyst precursor, a ligand, and optionally a solvent and one or more optional additives such as an oxidant, a reductant, an acid, a base, a small molecule additive such as carbon monoxide (CO), carbon dioxide (CO₂), and the like. The method can include heating the reaction vessels; and analyzing a combination of the contents of the reaction vessels for the presence of a conjugation product of the substrates. The presence of a conjugation product having a mass that is outside the range of any substrate, for example, at least approximately twice the mass of the two lowest mass substrates, confirms the occurrence of a conjugation reaction. The analysis of the combination of the contents of the reaction vessels can be by GC, LC, or a combination thereof.

In yet another embodiment, the invention provides a method comprising heating a test mixture to potentially initiate a metal-mediated conjugation reaction; wherein the test mixture initially comprises a combination of five, six, or seven or more reaction mixtures and optionally one or more control mixtures; and wherein each reaction mixture comprises a metal catalyst precursor, a ligand, and a diverse mixture of substrates, prior to heating or reaction initiation. The method can further include analyzing the test mixture for the presence of a conjugation product, wherein the mass of any conjugation product formed from a metal-mediated conjugation reaction exceeds the mass of any single substrate of the reaction mixtures by at least about 50%; thereby identifying a successful metal-mediated conjugation reaction by the presence of a conjugation product, wherein the presence of a conjugation product in the test mixture confirms that a metal-mediated conjugation reaction occurred in one or more of the reaction mixtures.

Accordingly, the invention provides new methods for identifying metal-mediated reactions, metal-ligand combinations for mediating reactions, and new reactions that employ a metal and ligand to facilitate a chemical bond between to substrates. The products can be used, for example, as intermediates for the synthesis of other useful compounds.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. GC-MS of the combination of reactions in the row containing Ni(cod)₂ as a metal catalyst precursor. The product from Ni-catalyzed alkyne carbocyanation was also detected in the GC/MS for the column with PBu₃, indicating that the combination of Ni(cod)₂ and PBu₃ catalyzes the reaction. FIG. 1A shows a GC chromatogram of the reaction products. FIG. 1B shows the mass spectrum of the compound with a GC peak at 18.1 minutes. The peak at 18.1 minutes corresponds to material with an m/z=291, which is the mass of the alkyne carbocyanation product.

FIG. 2. GC-MS of the combination of reactions in the row containing Cu(OAc)₂ as a metal catalyst precursor. The product from Cu-catalyzed oxidative coupling was observed. FIG. 2A shows a GC chromatogram of the reaction products. FIG. 2B shows the mass spectrum of the compound with a GC peak at 17.9 minutes. The peak at 17.9 minutes corresponds to material with an m/z=281, which is the mass of the amination product.

FIG. 3. ESI-MS of the combination of reactions in the row containing [Ru(p-cymene)Cl₂]₂ as a metal catalyst precursor. The peaks at m/z=339 and m/z=507 correspond to the products from Ru-catalyzed sulfonamide monoalkylation and dialkylation, respectively.

FIG. 4. GC-MS of the combination of reactions in the row containing Cu(OAc)₂ as a metal catalyst precursor. The product of Cu-catalyzed alkyne hydroamination with an aromatic amine is observed. This product was also observed in the GC-MS of the combination of reactions in the columns containing P(nBu)₃, the nacnac-type ligand, tri-p-tolylphosphite and the column with no ligand. FIG. 4A shows a GC chromatogram of the reaction products. FIG. 4B shows the mass spectrum of the compound with a GC peak at 17.8 minutes. The peak at 17.8 minutes corresponds to material with an m/z=315, which is the mass of the imine product. The same peak is observed for the row with CuCl as the metal catalyst precursor.

FIG. 5. GC-MS of the combination of reactions in the row containing Ni(cod)₂ as a metal catalyst precursor. The product of Ni-catalyzed alkyne hydroarylation with an aryl boronic acid was observed. This product was also observed in the GC-MS of the combination of reactions in the columns containing PPh₃, P(nBu)₃, PCy₃, dppf, dtbpy, Monophos, and SiPr, indicating that the reaction is catalyzed by the combination of Ni(cod)₂ and these ligands. FIG. 5A shows a GC chromatogram of the reaction products. FIG. 5B shows the mass spectrum of the compound with a GC peak at 18.6 minutes. The peak at 18.6 minutes corresponds to material with an m/z=312, which is the mass of the product from alkyne hydroarylation.

FIG. 6. Deconvolution strategy to identify coupling partners for products observed in high-throughput reaction discovery, according to an embodiment.

FIG. 7. GC-MS of the combination of reactions in the row containing Ni(cod)₂ as a metal catalyst precursor. The product of Ni-catalyzed alkyne hydroarylation with an aryl bromide was observed. The product from Ni-catalyzed alkyne hydroarylation with an aryl bromide was also observed in the GC-MS of the combination of reactions in the column with PBu₃, indicating that the reaction is catalyzed by a combination of Ni(cod)₂ and PBu₃. FIG. 7A shows a GC chromatogram of the reaction products. FIG. 7B shows the mass spectrum of the compound with a GC peak at 16.6 minutes. The peak at 16.6 minutes corresponds to material with an m/z=292, which is the mass of the alkyne hydroarylation product.

FIG. 8. Top View of Aluminum Well Plate with Glass Tubes used for Catalyst Screening.

FIG. 9. Side View of Aluminum Well Plate with Glass Tubes used for Catalyst Screening.

FIG. 10. Aluminum Well Plate used for Catalyst Screening with Top and Bottom Plates in place.

### DETAILED DESCRIPTION

Methods to screen for new chemical reactions catalyzed by a wide range of metal-ligand combinations are described herein. Many approaches to combinatorial catalyst discovery have been devised, but the approach described herein is the first in which many catalysts for many reactions are surveyed simultaneously. The methods are simple and amenable to a large format. Specifically, an array of catalysts and ligands with a diverse mixture of substrates can be screened. Mass spectrometry can then be used to identify coupling products that, by design, exceed the mass of any single substrate. Using this method, several new reactions have been discovered, including a copper catalyzed alkyne hydroamination reaction and two nickel-catalyzed hydroarylation reactions, all displaying excellent functional group tolerance.

Most methods for the high-throughput discovery of catalysts evaluate one of the two catalyst-reactant dimensions. In other words, these methods examine either many catalysts for a single class of reactions or a single catalyst for many reactions. A two-dimensional approach in which many catalysts for many catalytic reactions are tested simultaneously provides a more efficient discovery platform, if the reactants and products from such a system could be identified. A method is provided for the discovery of catalytic reactions by conducting experiments in an x-y array on pools of substrates having similar masses, and analyzing combinations of these pools by mass spectroscopy. This format evaluates thousands of reactions or potential reactions at one time and pinpoints with just a few mass spectral measurements the coordinates of the metal and ligand that effect a reaction between two or more substrates. The substrates can be a variety of small molecule substrates (e.g., having molecular weights of less than about 2000 Da, less than about 1500 Da, or less than about 1000 Da), and the substrates can lack traditional tags such as fluorescent groups, nucleic acids (e.g., DNA or RNA moieties), and the like. The analysis of the reaction mixtures can be carried out without separating the compounds in the reaction mixture, i.e., the analysis can be performed on the mixture of substrates and/or conjugation products in a reaction mixture.

### High-Throughput Catalytic Reaction Analysis

Complexes of transition metals catalyze many important reactions used in organic synthesis, medicine, materials science and energy production. Although various high-throughput methods for catalyst discovery have been developed, these methods have not been sufficiently general or accessible to be adopted widely. Described herein are simple methods that allow the evaluation of a broad range of catalysts for potential coupling reactions using simple laboratory equipment.

Mechanistic data often provide the foundation for catalyst development and optimization. However, many reactions were discovered serendipitously while seeking a different synthetic transformation. Here, a method is described to discover catalytic reactions, for example, by conducting experiments in an x-y array on pools of substrates having similar masses, and analyzing combinations of these pools with techniques such as by mass spectroscopy. This format evaluates thousands of reactions at one time and pinpoints with just a few mass spectral measurements the coordinates of the metal and ligand that effect a reaction between two or more substrates.

The invention thus provides a method comprising identifying a successful metal-mediated conjugation reaction by analyzing a test mixture for the presence of a conjugation product. The test mixture can include a combination of mixtures from numerous reactions. For example, the test mixture can include the mixtures from at least about nine reactions, for example from a 3×3 pool of reactions. The pool of reactions can be any size, such as 3×3, 4×4, 5×5, 6×6, 6×8, 8×8, 8×10, 8×12, or any desired combination of rows and columns, for example, on one or more 96-well plates.

Each reaction mixtures for combining into the test mixture can include a metal catalyst precursor, a ligand, a diverse mixture of substrates, and optionally a solvent and/or one or more additives. The mixture of substrates can be any number of substrates sought to be evaluated for their reactivity in a metal-mediated reaction. Each substrate can include a “functional group” that is known to react with a metal catalyst in a metal-mediated reaction. The number of substrates in each reaction mixture can be, for example, any integer greater than 3 up to about 25, or any range of integers from 4 to about 25.

Each individual substrate in the diverse mixture of substrates will typically include only one reactive functional group. In some embodiments, one or more substrates can include two or more reactive functional groups. Each reaction mixture can include a diverse mixture of substrates where the group of substrates includes at least 2, 3, 4, 5, or 6 different functional groups on the individual substrates in the reaction mixture. The masses of the substrates can be selected so that the mass of any conjugation product formed from a metal-mediated conjugation reaction lies outside the range of any single substrate in the diverse mixture of substrates. In some embodiments, the masses of the substrates can be selected such that the mass of any conjugation product formed from a metal-mediated conjugation reaction in the presence of the substrates will exceed the mass of any single substrate of the reaction mixtures by at least about 10%, at least about 20%, at least about 25%, at least about 30%, at least about 35%, at least about 40%, at least about 50%, at least about 60%, at least about 70%, at least about 80%, or at least about 90%.

One or more of the reaction mixtures can then be heated to initiate a potential metal-mediated conjugation reaction. Typically, all of the reaction mixtures are heated simultaneously. The method can also include reaction mixtures that exclude a ligand or metal catalyst precursor from one or more of the reaction mixtures. The presence of a conjugation product in the test mixture confirms that a metal-mediated conjugation reaction occurred in one or more of the reaction mixtures. In some embodiments, at least one conjugation product is present in the test mixture, thereby confirming a successful conjugation reaction in at least one of the reaction mixtures, which can be detected when the test mixture is analyzed.

Analyzing the test mixture for the presence of the conjugation product can include the use of liquid chromatograph (LC), high performance liquid chromatography (HPLC), gas chromatography (GC), mass spectrometry (MS), or a combination thereof. The method can include measuring the masses of non-polar products by, for example, gas chromatography/mass spectrometry (GC/MS). The method can also include measuring the masses of polar products by electrospray ionization mass spectrometry (ESI-MS). The test mixture can be worked up prior to analysis. For example, the test mixture can be neutralized, washed, filtered, and/or concentrated prior to the analysis.

The test mixture can be, for example, a combination of one row of an x-y array of reaction mixtures. The test mixture can also be a combination of one column or an x-y array of reaction mixtures. By selectively analyzing sets of columns and rows, the combination of metal catalyst precursor and ligand can be reduced to a smaller set, to aid in the identification of the final metal catalyst precursor-ligand combination or combinations that successfully initiated the reaction that resulted in the formation of the conjugation product.

The metal catalyst precursor can include a transition metal, an inner transition metal, or a main group metal. The metal catalyst precursor can be, for example, a first row transition metal, a second row transition metal, a third row transition metal, a lanthanide metal, an actinide metal, or metal or metalloid found in Groups I, II, III, IV, V, or VI. Specific examples of such metals are described in the definitions section below.

In some embodiments, each reaction mixture can include a different metal catalyst precursor, or a group of reaction mixtures can be arranged in an x-y array where each column or row includes the same metal catalyst precursor. Specific examples of metal catalyst precursors include, but are not limited to, Fe(acac)₂, MoCl₅, Ni(cod)₂, [Ru(p-cymene)Cl₂]₂, CuCl, Cu(OAc)₂, FeCl₃, NiCl₂-dme, Mn(acac)₂, Co(OAc)₂, AuCl, (benzene)Cr(CO)₃, W(CO)₃(MeCN)₃, Yb(OAc)₃, and Mo(CO)₃(EtCN)₃. Other metal catalyst precursors can be used, such as those available from Sigma-Aldrich Fine Chemicals, Strem, Acros Organics, and other commercial suppliers.

In some embodiments, each reaction mixture can include a different ligand, or a group of reaction mixtures can be arranged in an x-y array where each column or row includes the same ligand. Specific examples of ligands include, but are not limited to, PPh₃, PCy₃, PnBu₃, dppf, 2-aminocyclohexanol HCl, ethanolamine, 2-picolinic acid*, N,N′-diphenylbenzimidamide*, trans-1,2-diaminocyclohexane, TMEDA, tetramethylheptanedione*,N—((Z)-4-(phenylamino)pent-3-en-2-ylidene)aniline*, L-proline*, methylenebis(diphenylphosphine oxide)*, methylenebis(diphenylphosphine sulfide)*, diphenylphosphine oxide, SIPr—HCl*, Cod, P(O-p-tol)₃, Monophos [(3,5-Dioxa-4-phospha-cyclohepta[2,1-a;3,4-a′]dinaphthalen-4-yl)dimethylamine], BINOL, 4,4′-di-tert-butylbipyridine, or (N,N′E,N,N′E)-N,N′-(ethane-1,2-diylidene)bis(2,6-diisopropylaniline). Ligands marked with an asterisk can be treated with a base, such as NaH, prior to contacting the ligand with a metal catalyst precursor or substrate.

In some embodiments, diverse mixtures of substrates can include four or more substrates in each reaction mixture. Each reaction mixture, for example, can include 4, 5, 6, 7, 8, 9, 10, 11, 12, 13, 14, 15, 16, 17, 18, 19, 20, 21, 22, 23, 24, or about 25 different substrates, or any range between any two of the aforementioned integers. The reaction mixtures can be contained in any suitable reaction vessel such as a vial, a flask, a microtiter plate, a set of test tubes, or the like. The vessel can be sealed and the reaction can be carried out under an inert atmosphere, such as argon or nitrogen gas.

In some embodiments, the diverse mixture of substrates includes organic compounds, for example, those that include about 7 to about 20 heavy atoms selected from C, N, O, P, S, and F. The substrates can include, for example, organic compounds having molecular masses of about 100 Da to about 2 kDa. Some substrates can have molecular masses of about 200, about 300, about 400, about 500, about 600, about 750, about 1000, about 1250, about 1500, about 1750, about 2000, or any of the aforementioned masses plus and/or minus about 10%, about 20%, about 25%, about 30%, about 40%, or about 50%, or the substrate mass can be a range between any two of the aforementioned masses, or between any two of their plus/minus variations (including a specific maximum or minimum, as desired for a particular reaction mixture). However, the group of substrates should be selected such that the conjugation products can be identified in view of the range of masses of the substrates. For example, each of the substrates can have a mass of about 178 Da±50 Da. The minimum mass of a conjugate product would therefore be about 256, which is greater than the mass of any single substrates the range of 178 Da±50 Da.

Examples of a suitable groups of substrates includes, but is not limited to, substrates such as dodecane, 1-dodecene, 1-dodecyne, 1-dodecanol, 1-dodecylamine, decanonitrile, 4-bromo-1,2-difluorobenzene, 2-vinylnaphthalene, p-toluenesulfonamide, diphenylacetylene, 4-n-pentylphenol, 2-cyanonaphthalene, 4-tert-butylphenylboronic acid, 5-decyne, n-pentylbenzene, 4-n-Bu-aniline, and N-Bu-indole. Other suitable substrates, including substrates with more than one functional group, include one or more of hexanoic acid, cyclopropylacetic acid, cyclobutane carboxylic acid, 3-hexenoic acid, 6-heptynoic acid, phenylacetic acid, 4-iodobenzoic acid, 3-(2-furyl)propanoic acid, indole-5-carboxylic acid, succinic acid, adipic acid monomethyl ester, 6-oxoheptanoic acid, 5-chlorovaleric acid, p-formylbenzoic acid, acrylic acid, 5-oxiranyl pentanoic acid, 3-(4-hydroxy-phenyl)propionic acid, 5-methoxycarbonyl-4-oxopentanoic acid, 4-(2-carboxyethyl)benzeneboronic acid, 4-azidobutyric acid, 8-cyano-octanoic acid, and 6-hydroxycaproic acid. As would be readily recognized by one of skill in the art, other compounds and other substitutions can be used, as well as compounds with additional substitutions on the base carbon chain or aryl or heteroaryl ring.

In some embodiments, each reaction mixture includes only one metal catalyst precursor and the plurality, e.g., nine or more, reaction mixtures comprise three or more different metal catalyst precursors. In various embodiments, each reaction mixture includes only one ligand and the several, such as the nine or more, reaction mixtures comprise a total of three or more different ligands. Accordingly, multiple catalysts and reactants can be evaluated simultaneously.

The reaction mixtures can be heated, for example, for at least about 1 hour. Suitable reaction times can include anywhere from about 1 hour to about 24 hours, such as about 4 hours, about 8 hours, about 12, hours, or about 18 hours.

The reaction mixtures can be heated, for example, to any suitable temperature above room temperature (˜23° C.). For example, any one or more of the reaction mixtures can be heated to at least about 3° C., at least about 4° C., at least about 5° C., at least about 6° C., at least about 7° C., at least about 8° C., at least about 9° C., at least about 10° C., at least about 12° C., or at least about 15° C. In some embodiments, each of the reaction mixtures is heated simultaneously.

It can be advantageous for the reaction vessels containing the reaction mixtures to be arranged in an x-y array. Such a configuration can allow for convenient organization of the addition of metal catalyst precursors and ligands to the rows and columns of the x-y array. For example, each row of the array can contain the same metal catalyst precursor, and each column of the array can contain the same ligand, thereby creating an x-y array of reaction vessels, each with a different combination of metal catalyst precursors and ligands. Additionally, one row and one column may also exclude a metal catalyst precursor and a ligand, respectively. Such configurations can therefore include x-y arrays of about 9 to about 144 reaction mixtures. Convenient 96 well trays can be used, and reaction vessels from multiple trays can be combined for analysis. Therefore, the x-y array can include a plurality of different metal catalyst precursors, and plurality of different ligands.

An excess of the metal catalyst precursor can be added to each reaction mixture to avoid complete poisoning of the catalyst by one of the substrates. However, maybe reactions that can be discovered can be catalytic, where a conjugation reaction can occur with only a sub-stoichiometric amount of the eventual metal catalyst. Thus, the conjugation reaction can be catalytic with respect to the metal of the metal catalyst precursor. Furthermore, a molar excess of the metal catalyst precursor can be present in each reaction mixture, with respect to the largest molar amount of a substrate in the diverse mixture of substrates.

The invention also provides a deconvolution strategy, the method of which includes combining groups of the reaction mixtures with known subgroups of the metal catalyst precursors and ligands. By analyzing these subgroups, the range of metal catalyst precursors and ligand combinations the successfully initiated the conjugation reaction can be reduced. The method can further include dividing the diverse mixture of substrates into two or more subgroups, and adding metal catalyst precursors and ligands to the subgroups, where the metal catalyst precursors and ligands are selected from reaction mixtures or test mixtures that were known to successfully initiate the conjugation reaction. From this analysis, the range of potential metal catalyst precursors and ligand combinations can be further reduced. The method can be repeated, until the precise identity of the substrates, metal catalyst precursor, and ligand combinations are identified. The deconvolution strategy is further described in the examples below.

### New Metal-Mediated Reactions

The invention also provides a copper-catalyzed hydroamination reaction. Accordingly, the invention provides a method comprising preparing a compound of Formula I:

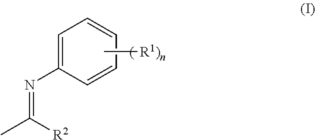

wherein

R¹ is —H, —OH, —(C₁-C₂₄)alkyl, (C₁-C₂₄)alkoxy, (C₁-C₂₄)acyl, (C₁-C₂₄)alkoxycarbonyl, (C₁-C₂₄)acyloxy, —CF₃, —NO₂, —CN, —CHO, or halo;

n is 1, 2, 3, 4, or 5; and

R² is (C₁-C₂₄)alkyl, aryl, heteroaryl, heterocycle, or —SiR'₃ where each R′ is independently alkyl, aryl, alkoxy, or aryloxy;

comprising contacting a compound of Formula II:

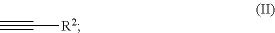

wherein R² is as defined above for Formula I;

and a compound of Formula III:

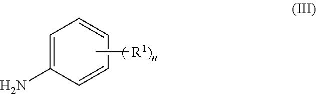

wherein R¹ is as defined above for Formula I; in the presence of CuCl or Cu(OAc)₂, to provide a reaction mixture, and heating the reaction mixture above 25° C., to provide the compound of Formula I. For example, the compounds of Formula II and III can be heated to a temperature of about 50° C. to about 150° C., or a temperature as described above the other reaction mixtures. The method can further include reducing the imine of Formula Ito an amine, for example, with a hydride reagent, such as NaBH₄ or NaBH₃CN. A catalytic amount of CuCl or Cu(OAc)₂ can be present in the reaction mixture. The reaction mixture can further include a ligand, such as PBu₃, a β-diketiminate (nacnac-type) ligand, or tri-p-tolylphosphite.

The invention also provides a nickel-catalyzed hydroarylation reaction, such as with an aryl boronic acid or an aryl or heteroaryl halide. Accordingly, the invention provides a method comprising preparing a compound of Formula V:

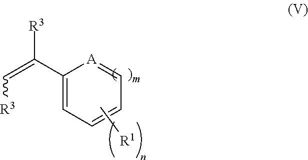

wherein

A is C, N, O, or S;

m is 1 when A is C, m is 0 when A is O or S, and m is 0 or 1 when A is N;

R¹ is —H, —OH, —(C₁-C₂₄)alkyl, —(C₁-C₂₄)alkoxy, (C₁-C₂₄)acyl, (C₁-C₂₄)alkoxycarbonyl, (C₁-C₂₄)acyloxy, —CF₃, —NO₂, —CN, —CHO, or halo; or two R¹ groups together form a fused benzo, furan, or thiophene ring on the ring of Formula V;

n is 1, 2, 3, 4, or 5; and

each R³ is independently H, —(C₁-C₂₄)alkyl, aryl, heteroaryl, heterocycle, or —SiR′₃ where each R′ is independently alkyl, aryl, alkoxy, or aryloxy; provided that both R³ groups are not H; and

the phenyl ring illustrated in Formula V is optionally a furan or thiophene ring;

comprising contacting a compound of Formula VI:

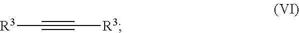

wherein R³ is as defined above for Formula V, provided that the compound of Formula VI is a liquid or solid at 23° C.;

and a compound of Formula VII:

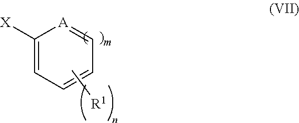

wherein

A, m, and R¹ are as defined above for Formula V; and

X is B(OH)₂, Br, or I; and the phenyl ring illustrated in Formula VII is optionally a furan or thiophene ring;

in the presence of Ni(cod)₂ or NiCl₂-dme, and a phosphine ligand or SIPr (1,3-bis(2,6-diisopropylphenyl)-4,5-dihydro-1H-imidazol-3-ium), to provide a reaction mixture; and heating the reaction mixture above 25° C., to provide the compound of Formula V.

Thus, the ring of Formula V can be a phenyl ring, a pyrrole ring, a furan ring, or a thiophene ring. As would be readily recognized by one of skill in the art, the double bond between A and the adjacent carbon in parentheses is absent when m is 0. Also, when A is C, the C is CH when unsubstituted and C when substituted; and when A is N, the N is NH when unsubstituted and N when substituted or when m is 1. Two R¹ groups of Formula V can form a 1,2-fused benzo, furan, or thiophene ring on the structure of Formula V, and any remaining R¹ groups can be a substituent on the ring of Formula V. In other embodiments, the ring of Formula V can be other heteroaryl structures as described in the definitions section below. For example, the ring of Formula V can be any five or six-membered heteroaryl ring or a bicyclic heteroaryl ring as described herein, for example, having one, two, or three heteroatoms in the ring system. Examples include thiazoles, imidazoles, pyrazoles, pyrimadines, and the like, e.g., where a second carbon of the ring of Formula V is independently a variable atom A.

A catalytic amount of Ni(cod)₂ or NiCl₂-dme can be present in the reaction mixture. The heating the compounds of Formula VI and VII can be to a temperature of about 50° C. to about 150° C., or a temperature as described above the other reaction mixtures.

The compound of Formula VI can be, for example, diphenylacetylene and each phenyl can be optionally substituted, for example, with one or two R³ groups.

In some embodiments, X is B(OH)₂ and the ligand is PPh₃, P(nBu)₃, PCy₃, dppf (1,1′-bis(diphenylphosphino)ferrocene), dtbpy (4,4′-di-tert-butyl-2,2′-bipyridine), Monophos, or SIPr. In various embodiments, the ligand is PPh₃ and the ratio of the anti-addition product to the syn-addition product of the compound of Formula V is at least about 1.5:1, about 2:1, about 3:1, about 4:1, about 5:1, about 6:1, about 7:1, or about 8:1.

In some specific embodiments, the compound of Formula VII is 4-tert-butylphenylboronic acid, 4-(trifluoromethyl)-phenylboronic acid, 4-formylphenylboronic acid, 4-cyanophenylboronic acid, 4-acetylphenylboronic acid, 4-methoxycarbonyl-phenylboronic acid, 4-chlorophenylboronic acid, benzofuran-2-boronic acid, thiophene-2-boronic acid, or benzofuran-2-boronic acid.

In another embodiment, X is Br or I and the ligand is P(nBu)₃. The reaction mixture can further include Et₃SiH, including an excess of Et₃SiH, such as one, two, or more equivalents thereof.

In some embodiments, the ligand is PPh₃ and the ratio of the anti-addition product to the syn-addition product of the compound of Formula V is at least about 1.5:1, about 2:1, about 3:1, about 4:1, about 5:1, about 6:1, about 7:1, or about 8:1.

In some specific embodiments, the compound of Formula VII is 2-bromotoluene, methyl 2-bromobenzoate, 5-bromobenzofuran, or 2-bromothiophene.

Any suitable solvent or solvent system can be used to aid the combining of the reaction substrates and reagents. Suitable examples include ether, THF, and other solvents and combinations thereof described in the definitions section below.

### Definitions

As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R.J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation.

The term “and/or” means any one of the items, any combination of the items, or all of the items with which this term is associated. The phrase “one or more” is readily understood by one of skill in the art, particularly when read in context of its usage. For example, one or more substituents on a phenyl ring refers to one to five, or one to four, for example if the phenyl ring is disubstituted. In various embodiments, one or more can refer to 1, 2, 3, 4, 5, 6, 7, 8, 9, or 10; for example, 1-4, 1-6, 1-8, or 1-10.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values, e.g., weight percents, proximate to the recited range that are equivalent in terms of the functionality of the individual ingredient, the composition, or the embodiment.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

The substrates of the reaction mixtures can include various base heavy atom chains and ring structures, optionally substituted with one or more substituents. Examples of many suitable chains and ring structures that can be substrates, or substituents on substrates, are described below.

The terms “halogen” and “halo”, and “halide” refer to fluoro, chloro, bromo, and iodo groups, typically used as organic substrate substituents.

The term “alkyl” refers to a branched or unbranched carbon chain having, for example, about 1-20 carbon atoms, and often 1-12, 1-10, 1-8, 1-6, or 1-4 carbons. Examples include, but are not limited to, methyl, ethyl, 1-propyl, 2-propyl, 1-butyl, 2-methyl-1-propyl, 2-butyl, 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, as described in the definition of the term “substituted” below.

The alkyl can also be optionally partially or fully unsaturated in certain embodiments. As such, the recitation of an alkyl group optionally includes both alkenyl and alkynyl groups. The alkyl can be a monovalent hydrocarbon radical, as described and exemplified above, or it can be a divalent hydrocarbon radical (i.e., an alkylene), for example, that links to other groups. In some embodiments, certain alkyl groups can be excluded from a definition. For example, in some embodiments, methyl, ethyl, propyl, butyl, or a combination thereof, can be excluded from a specific definition of alkyl in an embodiment.

The term “alkoxy” refers to the groups alkyl-O—, where alkyl is defined herein. Preferred alkoxy groups include, e.g., methoxy, ethoxy, n-propoxy, iso-propoxy, n-butoxy, tert-butoxy, sec-butoxy, n-pentoxy, n-hexoxy, 1,2-dimethylbutoxy, and the like. The alkoxy can be unsubstituted or substituted.

The term “alkenyl” refers to a monoradical branched or unbranched partially unsaturated hydrocarbon chain (i.e. a carbon-carbon, sp² double bond) preferably having from 2 to 10 carbon atoms, about 2 to 6 carbon atoms, or about 2 to 4 carbon atoms. Examples include, but are not limited to, ethylene or vinyl, allyl, cyclopentenyl, and 5-hexenyl. An alkenyl can be unsubstituted or substituted.

The term “alkynyl” refers to a monoradical branched or unbranched hydrocarbon chain, having a point of complete unsaturation (i.e. a carbon-carbon, sp triple bond), typically having from 2 to 10 carbon atoms, about 2 to 6 carbon atoms, or about 2 to 4 carbon atoms. This term is exemplified by groups such as ethynyl, 1-propynyl, 2-propynyl, 1-butynyl, 2-butynyl, 3-butynyl, 1-hexynyl, 2-hexynyl, 3-hexynyl, and the like. An alkynyl can be unsubstituted or substituted.

An “alkylene” refers to a saturated, branched or straight chain hydrocarbon radical of 1-18 carbon atoms, and having two monovalent radical centers derived by the removal of two hydrogen atoms from the same or two different carbon atoms of a parent alkane. Typical alkylene radicals include, but are not limited to, methylene (—CH₂—) 1,2-ethyl (—CH₂CH₂—), 1,3-propyl (—CH₂CH₂CH₂—), 1,4-butyl (—CH₂CH₂CH₂CH₂—), and the like. An alkylene can be unsubstituted or substituted.

The term “cycloalkyl” refers to cyclic alkyl groups of, for example, 3 to about 12, 3 to about 10, 3 to about 8, about 4 to about 8, or 5-6, carbon atoms having a single cyclic ring or multiple condensed rings. Cycloalkyl groups include, by way of example, single ring structures such as cyclopropyl, cyclobutyl, cyclopentyl, cyclooctyl, and the like, or multiple ring structures such as adamantyl, and the like. The cycloalkyl can be unsubstituted or substituted. The cycloalkyl group can be monovalent or divalent, and can be optionally substituted as described for alkyl groups. The cycloalkyl group can optionally include one or more cites of unsaturation, for example, the cycloalkyl group can include one or more carbon-carbon double bonds, such as, for example, 1-cyclopent-1-enyl, 1-cyclopent-2-enyl, 1-cyclopent-3-enyl, cyclohexyl, 1-cyclohex-1-enyl, 1-cyclohex-2-enyl, 1-cyclohex-3-enyl, and the like.

As used herein, “aryl” refers to an aromatic hydrocarbon group derived from the removal of one hydrogen atom from a single carbon atom of a parent aromatic ring system. The radical attachment site can be at a saturated or unsaturated carbon atom of the parent ring system. The aryl group can have from 6 to about 20 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted, as described for alkyl groups.

The term “heteroaryl” refers to a monocyclic, bicyclic, or tricyclic ring system containing one, two, or three aromatic rings and containing at least one nitrogen, oxygen, or sulfur atom in an aromatic ring, and that can be unsubstituted or substituted, for example, with one or more, and in particular one to three, substituents, as described in the definition of “substituted”. Typical heteroaryl groups contain 2-20 carbon atoms in addition to the one or more hetoeroatoms. Examples of heteroaryl groups include, but are not limited to, 2H-pyrrolyl, 3H-indolyl, 4H-quinolizinyl, acridinyl, benzo[b]thienyl, benzothiazolyl, β-carbolinyl, carbazolyl, chromenyl, cinnolinyl, dibenzo[b,d]furanyl, furazanyl, furyl, imidazolyl, imidizolyl, indazolyl, indolisinyl, indolyl, isobenzofuranyl, isoindolyl, isoquinolyl, isothiazolyl, isoxazolyl, naphthyridinyl, oxazolyl, perimidinyl, phenanthridinyl, phenanthrolinyl, phenarsazinyl, phenazinyl, phenothiazinyl, phenoxathiinyl, phenoxazinyl, phthalazinyl, pteridinyl, purinyl, pyranyl, pyrazinyl, pyrazolyl, pyridazinyl, pyridyl, pyrimidinyl, pyrimidinyl, pyrrolyl, quinazolinyl, quinolyl, quinoxalinyl, thiadiazolyl, thianthrenyl, thiazolyl, thienyl, triazolyl, tetrazolyl, and xanthenyl. In one embodiment the term “heteroaryl” denotes a monocyclic aromatic ring containing five or six ring atoms containing carbon and 1, 2, 3, or 4 heteroatoms independently selected from non-peroxide oxygen, sulfur, and N(Z) wherein Z is absent or is H, O, alkyl, aryl, or —(C₁-C₆)alkylaryl. In some embodiments, heteroaryl denotes an ortho-fused bicyclic heterocycle of about eight to ten ring atoms derived therefrom, particularly a benz-derivative or one derived by fusing a propylene, trimethylene, or tetramethylene diradical thereto.

The term “heterocycle” refers to a saturated or partially unsaturated ring system, containing at least one heteroatom selected from the group oxygen, nitrogen, silicon, and sulfur, and optionally substituted with one or more groups as defined for the term “substituted”. A heterocycle can be a monocyclic, bicyclic, or tricyclic group. A heterocycle group also can contain an oxo group (═O) or a thioxo (═S) group attached to the ring. Non-limiting examples of heterocycle groups include 1,3-dihydrobenzofuran, 1,3-dioxolane, 1,4-dioxane, 1,4-dithiane, 2H-pyran, 2-pyrazoline, 4H-pyran, chromanyl, imidazolidinyl, imidazolinyl, indolinyl, isochromanyl, isoindolinyl, morpholinyl, piperazinyl, piperidinyl, pyrazolidinyl, pyrazolinyl, pyrrolidine, pyrroline, quinuclidine, tetrahydrofuranyl, and thiomorpholine, where the point of attachment can be at any atom accessible by known synthetic methods.

When an aryl, heteroaryl, heterocycle, or cycloalkyl group is a substituent, the group can be linked to the substrate via an alkylene group, thereby providing (alkyl)aryl, (alkyl)heteroaryl, (alkyl)heterocycle, or (alkyl)cycloalkyl substituents.

The terms “acyl” and “alkanoyl” refer to groups of the formula —C(═O)R, where R is an alkyl group as previously defined. The term “aroyl” refers to groups of the formula —C(═O)Ar, where Ar is an aryl group as previously defined.

The term “alkoxycarbonyl” refers to groups of the formula —C(═O)OR, where R is an alkyl group as previously defined.

The term “acyloxy” refers to groups of the formula —O—C(═O)R, where R is an alkyl group as previously defined. Examples of acyloxy groups include acetoxy and propanyloxy.

The term “amino” refers to —NH₂, and the term “alkylamino” refers to —NR₂, wherein at least one R is alkyl and the second R is alkyl or hydrogen. The term “acylamino” refers to RC(═O)NH—, wherein R is alkyl or aryl.

The term “substituted” indicates that one or more hydrogen atoms on the group indicated in the expression using “substituted” is replaced with a “substituent”. The number referred to by ‘one or more’ can be apparent from the moiety one which the substituents reside. For example, one or more can refer to, e.g., 1, 2, 3, 4, 5, or 6; in some embodiments 1, 2, or 3; and in other embodiments 1 or 2. The substituent can be one of a selection of indicated groups, or it can be a suitable group known to those of skill in the art, provided that the substituted atom's normal valency is not exceeded, and that the substitution results in a stable compound. Suitable substituent groups can be included on substrates described herein, such as the various heavy atom chains and ring structures, include, e.g., alkyl, alkenyl, alkynyl, alkoxy, halo, haloalkyl, hydroxy, hydroxyalkyl, aryl, aroyl, (aryl)alkyl (e.g., benzyl or phenylethyl), heteroaryl, heterocycle, cycloalkyl, alkanoyl, alkoxycarbonyl, amino, alkylamino, dialkylamino, trifluoromethyl, trifluoromethoxy, trifluoromethylthio, difluoromethyl, acylamino, nitro, carboxy, carboxyalkyl, keto, thioxo, alkylthio, alkylsulfinyl, alkylsulfonyl, arylsulfinyl, arylsulfonyl, heteroarylsulfinyl, heteroarylsulfonyl, heterocyclesulfinyl, heterocyclesulfonyl, phosphate, sulfate, hydroxylamine, hydroxyl (alkyl)amine, and cyano. Additionally, suitable substituent groups can be, e.g., —X, —R, —B(OH)₂, —B(OR)₂, —O—, —OR, —SR, —S—, —NR₂, —NR₃, ═NR, —CX₃, —CN, —OCN, —SCN, —N═C═O, —NCS, —NO, —NO₂, ═N₂, —N₃, —NC(═O)R, —C(═O)R, —C(═O)NRR, —S(═O)₂O—, —S(═O)₂OH, —S(═O)₂R, —OS(═O)₂OR, —S(═O)₂NR, —S(═O)R, —OP(═O)O₂RR, —P(═O)O₂RR, —P(═O)(O)₂, —P(═O)(OH)₂, —C(═O)R, —C(═O)X, —C(S)R, —C(O)OR, —C(O)O—, —C(S)OR, —C(O)SR, —C(S)SR, —C(O)NRR, —C(S)NRR, or —C(NR)NRR, where each X is independently a halogen (“halo”): F, Cl, Br, or I; and each R is independently H, alkyl, aryl, (aryl)alkyl (e.g., benzyl), heteroaryl, (heteroaryl)alkyl, heterocycle, heterocycle(alkyl), or a protecting group. As would be readily understood by one skilled in the art, when a substituent is keto (═O) or thioxo (═S), or the like, then two hydrogen atoms on the substituted atom are replaced. In some embodiments, one or more of the substituents above are excluded from the group of potential values for substituents on the substituted group.

Substituted alkyl groups include, for example, haloalkyl groups. The term “haloalkyl” refers to alkyl as defined herein substituted by 1-4 halo groups, which may be the same or different. Representative haloalkyl groups include, by way of example, trifluoromethyl, 3-fluorododecyl, 12,12,12-trifluorododecyl, 2-bromooctyl, 3-bromo-6-chloroheptyl, perfluorooctyl, and the like.

As to any of the above groups, which contain one or more substituents, it is understood, of course, that such groups do not contain any substitution or substitution patterns that are sterically impractical and/or are synthetically non-feasible. It will be appreciated that the substrates described herein may contain asymmetrically substituted carbon atoms, and may be isolated in optically active or racemic forms. All chiral, diastereomeric, racemic forms and all geometric isomeric forms of a structure are part of this invention.

The term “contacting” refers to the act of touching, making contact, or of bringing to immediate or close proximity, including at the cellular or molecular level, for example, to bring about a physiological reaction, a chemical reaction, or a physical change, e.g., in a solution or in a reaction mixture.

An “effective amount” refers to an amount effective to bring about a recited effect. For example, an amount effective of a catalyst can be the amount of a catalyst effective to facilitate the formation of products in a reaction, under a certain set of conditions. Thus, an “effective amount” generally means an amount that provides the desired effect. Determination of an effective amount is well within the capacity of persons skilled in the art, especially in light of the detailed disclosure provided herein.

The phrase “metal mediated reaction” refers to a reaction carried out on one or more organic substrates that requires the presence of a metal to proceed from the one or more substrates to a product. The reaction can be facilitated by the metal, for example, in a stoichiometric amount, or the reaction can be catalyzed by the metal, where the reaction requires only a sub-stoichiometric amount of the metal. Typical metals for mediating organic reactions include the transition metals and the lanthanides. The metals can be in a zero oxidation state, or in any oxidized state attributable to the metal, where the metal can then be associated with one or more ligands to form a metal-ligand combination, such as a transition metal complex. A metal mediated reaction can be catalyzed when a metal catalyst precursor is in the presence of suitable ligands and substrates.

A “metal catalyst precursor” refers to a metal or metal complex that can act as a catalyst in the presence of an appropriate substrate or pair of substrates. In some embodiments, the metal catalyst precursor can be activated by treatment with an additive such as a base and/or a suitable ligand. Metal catalyst precursors can be described by the formula M(L)n wherein M is a metal, L is a ligand or substituent, and n is 0-6. Examples of the metal ligand include chloro, bromo, iodo, fluoro, oxo, hydroxy, hydroperoxy, alkoxy, aryloxy, acyloxy, acetoacetyl, carboxy, nitro, amino, alkylamino, dialkylamino, azido, carbonyl, alkyl, alkenyl, dienyl, aryl, triflate, arylsulfonyl.

The metal of a metal catalyst precursor can be, for example, a transition metal. The transition metal can be a first row, second row, or third row transition metal. First row transition metals include scandium (Sc), titanium (Ti), vanadium (V), chromium (Cr), manganese (Mn), iron (Fe), cobalt (Co), nickel (Ni), copper (Cu), and zinc (Zn). Second row transition metals include yttrium (Y), zirconium (Zr), niobium (Nb), molybdenum (Mo), ruthenium (Ru), rhodium (Rh), palladium (Pd), silver (Ag), cadmium (Cd). Third row transition metals include hafnium (Hf), tantalum (Ta), tungsten (W), rhenium (Re), osmium (Os), iridium (Ir), platinum (Pt), gold (Au), and mercury (Hg). Other metals that can be used as metal catalyst precursors include indium (In), tin (Sn), thallium (Tl), lead (Pb), cerium (Ce), samarium (Sm), and ytterbium (Yb), aluminum (Al), and metaloids such as boron (B).

Specific examples of metal catalyst precursors include, but are not limited to, Fe(acac)₂, MoCl₅, Ni(cod)₂, [Ru(p-cymene)Cl₂]₂, CuCl, Cu(OAc)₂, FeCl₃, NiCl₂-dme, Mn(acac)₂, Co(OAc)₂, AuCl, (benzene)Cr(CO)₃, W(CO)₃(MeCN)₃, Yb(OAc)₃, and Mo(CO)₃(EtCN)₃. Additional examples include Ti(OR₄), CrCl₂, FeCl₂, CoCl₂, NiCl₂, CuCl₂, ZnCl₂, ZnBr₂, Zr(OR)₄, RuCl₂, PdCl₂, AgOTf, WOCl₄, YbCl₃, BCl₃, AlCl₃, TaCl₅, Re₂(CO)₁₀, Re(CO)₅Br, IrCl₃, RhCl₃, Os₃(CO)₁₂, OsCl₃, OsO₄, and the like, where R is a lower alkyl, e.g., a (C₁-C₆)alkyl or (C₁-C₄)alkyl.

A “ligand” refers to an organic compound or moiety that can coordinate with a metal in a suitable oxidation state. Examples of ligands include amines, alcohols, alkenes such as cyclooctadiene, arenes, carboxylic acids, carbon monoxide, nitriles, ethers, halides, heterocyclic and heteroaryl amines such as pyrrolidines, piperidines, pyridines and, phosphines, ketones, phosphine oxides, phosphine sulfides, and amidinates.

Numerous catalysts, metal catalyst precursors, and metal ligands are well known in the art. Examples include those described in The Organometallic Chemistry of the Transition Metals (R. H. Crabtree, John Wiley & Sons: New York, 1988), Transition Metals in the Synthesis of Complex Organic Molecules (L. S. Hegedus, University Science Books: Mill Valley, Calif., 1994), and Organotransition Metal Chemistry (J. F. Hartwig, University Science Books: Sausalito, Calif., 2010), which are incorporated herein by reference. Many catalysts, metal catalyst precursors, and metal ligands can be obtained from commercial suppliers such as Sigma-Aldrich (St. Louis, Mo.), Acros Organics (distributed by Fisher Scientific, Pittsburgh, Pa.), or Strem Chemicals, Inc. (Newburyport, Mass.).

A “transition metal complex” refers to a transition metal in an oxidized state in combination with one or more ligands.

A “catalytic transformation” refers to an organic reaction that can occur in the presence of a catalyst, i.e., a reactant that facilitates the reaction but is not consumed and is not found in the resulting product of the reaction, and wherein the catalyst is required in less than a stoichiometric amount.

A “conjugation reaction” refers to a coupling reaction, or to combining of two substrates by the installation of a chemical bond. In a typical conjugation reaction, two separate substrates are combined in a reaction mixture with one or more reagents, and under appropriate reaction conditions, a covalent bond is formed between the two substrates, often with concomitant loss of common small molecules, such as H₂O, NH₃, H₂, HCN, or common leaving groups such as halides, boric acid, boronic acid or other boronyl groups, and protons, or combinations thereof.

A “conjugation product” or “coupling product” refers to a product of a conjugation reaction, i.e., a chemical compound that has been formed by the joining of two or more compounds. As used herein, the mass of the conjugation product typically exceeds the mass of any single substrate used to prepare the products.

As used herein, a “reactant” or “substrate” refers to an organic compound having about 7 to about 20 heavy atoms selected from C, N, O, F, S, and optionally one or more functional groups on the compound. In some embodiments, the substrate can have about 10 to about 13 heavy atoms (C, N, O, F, S). The substrate can possess a single functional group that is reactive to a metal catalyst, for example, a “leaving group”, such that a metal catalyst can insert itself between the leaving group and the remainder of the substrate molecule. Examples of the substrate functional group include acidic hydrogen atoms, internal alkenes, terminal alkenes, aryl alkenes, internal alkynes, terminal alkynes, alkyne substituted aryl groups, primary alcohols, secondary alcohols, aryl alcohols, primary amines, secondary amines, aryl amines, primary nitriles, secondary nitriles, aryl nitriles, aryl groups, indole groups, aryl halides, alkyl halides (primary or secondary), aryl boronic acids, and aryl sulfonamides. Specific examples include the compounds shown in Scheme 1 below.

A “diverse mixture of substrates” refers to a group of substrates with at least three, at least four, or at least five different functional groups on individual members of the substrates. Substrates can have two or more functional groups on an individual member but for initial reaction screening techniques, one potentially reactive functional group per substrate is sufficient.

A “reaction vessel” refers to any container that can house a reaction mixture, and/or in which a conjugation reaction can take place. Suitable examples include flasks, test tubes, and vials. The vessel can be made of any suitable material such as glass, polypropylene, and the like.

The reactions can be carried out in any suitable solvent or solvent system. The term “solvent” refers to any liquid that can dissolve an organic compound, such as a substrate or ligand, to form a solution. Solvents include water and various organic solvents, such as hydrocarbon solvents, for example, alkanes and aryl solvents, as well as chloroalkane solvents. Suitable solvents include organic solvents that do not react with the substrates or catalyst in a manner that inhibits a reaction from occurring. Suitable solvents may include ether, tetrahydrofuran (THF), benzene, toluene, xylenes, methylene chloride, chloroform, dichloroethane, dimethyl sulfoxide (DMSO), dimethyl formamide (DMF), dimethyl acetamide (DMA), and the like. Some reactions may also be carried out in solvents such as ethyl acetate, hexanes, acetone, acetic acid, and alcoholic solvents such as methanol, ethanol, propanol, isopropanol, and linear or branched (sec or tert) butanol, and the like. Combinations of solvents can also be used. For example, the solvent used in a reaction mixture can be a single solvent, such as water (an aqueous system) or ethanol (an alcoholic system, which may also include various amounts of water), or a combination of two or more solvents (e.g., a hydroalcoholic system, or combination of other miscible solvents such as water, ethanol, DMF, DMSO, and the like), or one or more of the solvents listed above. Thus, the solvent system can be a single solvent, or a combination of solvents, optionally with one or more additives, such as a base to activate a compound to act as a ligand.

Any reaction mixture can also include one or more additives. An additive can be an oxidant, a reductant, an acid, a base, an additional small-molecule component such as carbon monoxide (CO) or carbon dioxide (CO₂), or any other component of a reaction mixture that can facilitate a metal-mediated reaction. Examples of oxidants include KMnO₄; Br₂; I₂; peroxides such as H₂O₂ and peracetic acid; oxygen (O₂); ozone (O₃); hypervalent iodine oxidants such as PhIO, PhI(OAc)₂, and PhI(OPiv)₂; benzoquinone; and the like. Examples of reductants include H₂, H₂S, NaH, LiAlH₄, NaBH₄, DiBAlH, H₂NNH₂, Zn—Hg amalgam, Lindlar's catalyst, oxalic acid, formic acid, ascorbic acid, dithiothreitol, organosilanes, hydroboranes, and the like. Examples of acids include organic acids and mineral acids such as acetic acid, trifluoroacetic acid, TsOH, sulfuric acid, nitric acid, chromic acid, perchloric acid, tartaric acid, hydrogen halides, boric acid, and Lewis acids such as BF₃ and AlCl₃. Examples of bases include organic bases and inorganic bases such as alkali metal hydroxides, alkaline earth metal hydroxides, alkaline earth metal carbonates, alkaline earth metal oxides, metal alkoxides, Lewis bases such as ammonia and alkyl amines, and the like. The small molecule additive can have, or example, 2-10 atoms and a molecular weight of about 28 to about 180, about 44 to about 150, or about 50 to about 120. The various additives can be any component of a reaction mixture that can aid in facilitating a metal-mediated reaction. Additional examples include an various organometallic compound and the like, such as CeCl₃, NiCl₂, Ti(OiPr)₄, ZnCl₂, Cu(OTf)₂, InCl₃, Sc(OTf)₃, BF₃OEt₂, and Bi(OTf)₃.

A “test mixture” refers to a mixture formed by combining several (e.g., four or more) reaction mixtures from the screening process. The test mixture can include the entire contents of the reaction mixtures, or the test mixture can include aliquots from the reaction mixtures. For example, the test mixture can include aliquots from several reaction mixtures, e.g., about 4, about 5, about 6, about 7, about 8, about 9, about 10, about 11, about 12, about 13, about 14, about 15, about 16, about 17, about 18, about 19, about 20, about 21, about 22, about 23, about 24, or about 25 reaction mixtures. Typical test mixtures can include combinations of a convenient group of reaction mixtures, such as one row or one column of an x-y matrix of reaction mixtures. The test mixture can be formed from reaction mixtures that were run in parallel, or from reaction mixtures that were initiated at different times and/or in different matrices. One advantage of using a test mixture is that numerous reaction mixtures can be screened at one time for the presence of a conjugation reaction product that has a mass suitably larger than the mass of any one substrate in any of the reaction mixtures.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1

### A Multi-Dimensional Approach to High-Throughput Discovery of Reactions

In one study, the core experiment was conducted with a set of 17 organic reactants, each of which contains 10 to 13 heavy atoms (C, N, O, F, S) and possesses a single functional group or a single most reactive functional group (e.g., a “leaving group”) (Scheme 1).

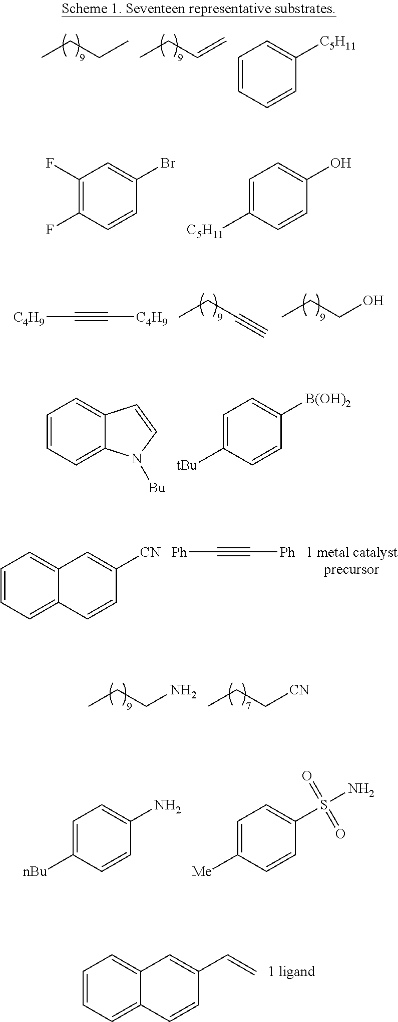

The combination of 17 substrates was placed into each reaction well of a 12×8 matrix. Twelve ligands were dispensed, one into each well of a column, and eight metal catalyst precursors were dispensed, one into each well of a row. The plate was sealed and heated at 100° C. for 18 hours. The contents of the wells in the plate were then analyzed by mass spectrometry. The number of substrates is arbitrary; the 17 substrates are merely a representative set, not a comprehensive set, of typical organic compounds and functional groups.

A group of catalysts derived from Mn, Fe, Cr, Co, Cu, Ni, and W was chosen due to their abundance and low cost. In addition, the reactivity of Ru, Mo, Yb and Au complexes was examined (Table 1). The ligands that were combined with these metals included common phosphines and amines, as well as less explored phosphine oxides, phosphine sulfides and amidinates (Table 2). Excess of the metal complexes were used in this system to alleviate poisoning all of the potential catalysts by one substrate. Reactions discovered in such a system can be rendered catalytic after initial identification of the transformation and metal-ligand combination that induces the transformation. The 17 substrates, in combination with catalysts derived from 15 metal centers and 23 ligands or the absence of a ligand, corresponds to more than 50,000 reactions. These reactions were conducted in a few days, after developing the protocol described herein.

TABLE 1
Representative Metal Catalyst Precursors.

| | |
|---|---|
| 1) | Fe(acac)₂ |
| 2) | FeCl₃ |
| 3) | Mo(CO)₃(EtCN)₃ |
| 4) | MoCl₅ |
| 5) | Mn(acac)₂ |
| 6) | W(CO)₃(MeCN)₃ |
| 7) | Yb(OAc)₃ |
| 8) | Cr(CO)₃(C₆H₆) |
| 9) | Co(OAc)₂ |
| 10) | Ni(cod)2 |
| 11) | CuCl |
| 12) | Cu(OAc)₂ |
| 13) | [Ru(p-cymene)Cl₂]₂ |
| 14) | AuCl |
| 15) | NiCl₂-dme |
| 16) | none |

TABLE 2
Representative Metal Catalyst Ligands.

| | |
|---|---|
| 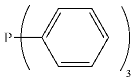 | A |
| 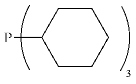 | B |
| 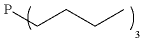 | C |
| 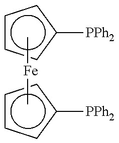 | D |
| 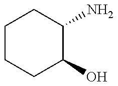 | E |
| 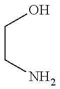 | F |
| 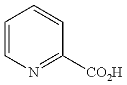 | G^{a} |
| 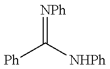 | H^{a} |
| 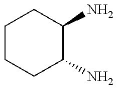 | I |
| 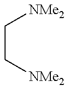 | J |
| 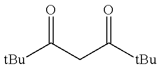 [SMILES: CC(C)(C)C(=O)CC(=O)C(C)(C)C] | K^{a} |
| 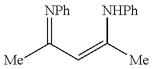 | L^{a} |
| 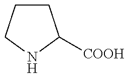 | M^{a} |
| 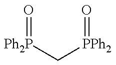 | N^{a} |
| 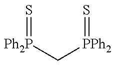 | O^{a} |
| 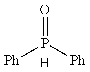 | P |
| 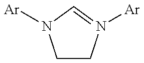 | Q^{a} |
| 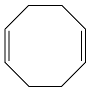 | R |
| 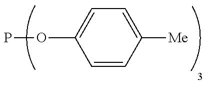 | S |
| none | T |
| 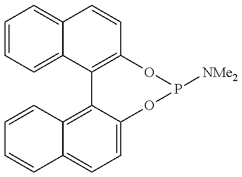 [SMILES: CN(C)p1oc2ccc3ccccc3c2c2c(ccc3ccccc32)o1] | U |
| 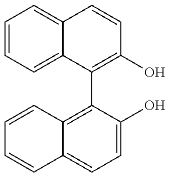 [SMILES: Oc1ccc2ccccc2c1-c1c(O)ccc2ccccc12] | V^{a} |
| 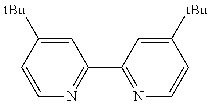 [SMILES: CC(C)(C)c1ccnc(-c2cc(C(C)(C)C)ccn2)c1] | W |
| 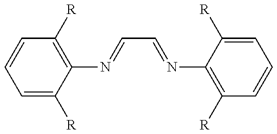 | X |

Ar = 2,6-di-iPr-C₆H₃
R = iPr
^{a}Ligand activated with base before reaction

A reaction between two of the substrates would produce a product with a mass that would lie outside of the range of masses of any of the reactants. Mass spectral data was obtained by a combination of gas chromatography/mass spectrometry (GC/MS) to measure the masses of non-polar products and electrospray ionization mass spectrometry (ESI-MS) to measure the masses of polar products. Previously, custom mass spectrometers have been used to analyze by tandem MS-MS methods the activity of charged catalysts for reactions conducted in the gas phase. These MS-MS methods have focused on comparing several catalysts for a single reaction, such as olefin polymerization and olefin metathesis (see Chen, Angew. Chem. Int. Ed. 42, 2832 (2003); Hinderling and Chen, Int. J. Mass Spectrom. 195-196, 377 (2000); Hinderling and Chen, Angew. Chem. Int. Ed. 38, 2253 (1999); and Volland et al., Chem. Eur. J. 7, 4621 (2001)). Mass spectrometry also has been used to analyze the binding of encoded organic ligands to biological targets (see Geysen et al., Chem. Biol. 3, 679 (1996)). The approach described herein does not require such encoding but encoding can be used as an optional additional technique. The mass of potential products from joining two substrates is easily calculated from the masses of the reactants, including the masses of potential products formed with concomitant loss of common small molecules, such as H₂O, NH₃, H₂, and HCN, or common leaving groups, such as halides. Several additional design elements were used, including the placement of different substituents on aryl groups to discriminate between them by their distinct mass spectral fragmentation patterns.

The catalyst components for the initial implementation of this strategy were chosen to identify earth-abundant metals that catalyze reactions previously induced by precious metal complexes. Although progress has been made toward the goal of catalyzing reactions using first-row transition metals, the smaller body of mechanistic information on reactions catalyzed by such systems makes high-throughput discovery methods to evaluate particularly appealing. The specific metals and ligands used in these experiments are depicted in Tables 1 and 2. The reactions identified in this format would necessarily have the high degree of functional-group tolerance most often needed to prepare natural products and medicinally important compounds (see Cooper et al., Angew. Chem. Int. Ed. 49, 8082 (2010)) because they were identified in a medium containing a wide range of additional functional groups.

To minimize the number of mass spectra, in anticipation of conducting such studies on a large format, reaction products were analyzed by creating eight samples containing a portion of the contents of each row and twelve samples containing a portion of the contents of each column of a 96-well plate. By this method, only 20 mass spectra on each 96-well plate are needed to identify the x-y coordinates of the metal-ligand combination that gives rise to a reaction product. These coordinates correspond to the row and column containing the same reaction product. In some cases, the product (and therefore the reaction partners) would be difficult to determine from the mass spectrum alone. Therefore, an additional protocol was devised to identify the product within a particular well by running a small set of additional experiments (vide infra).

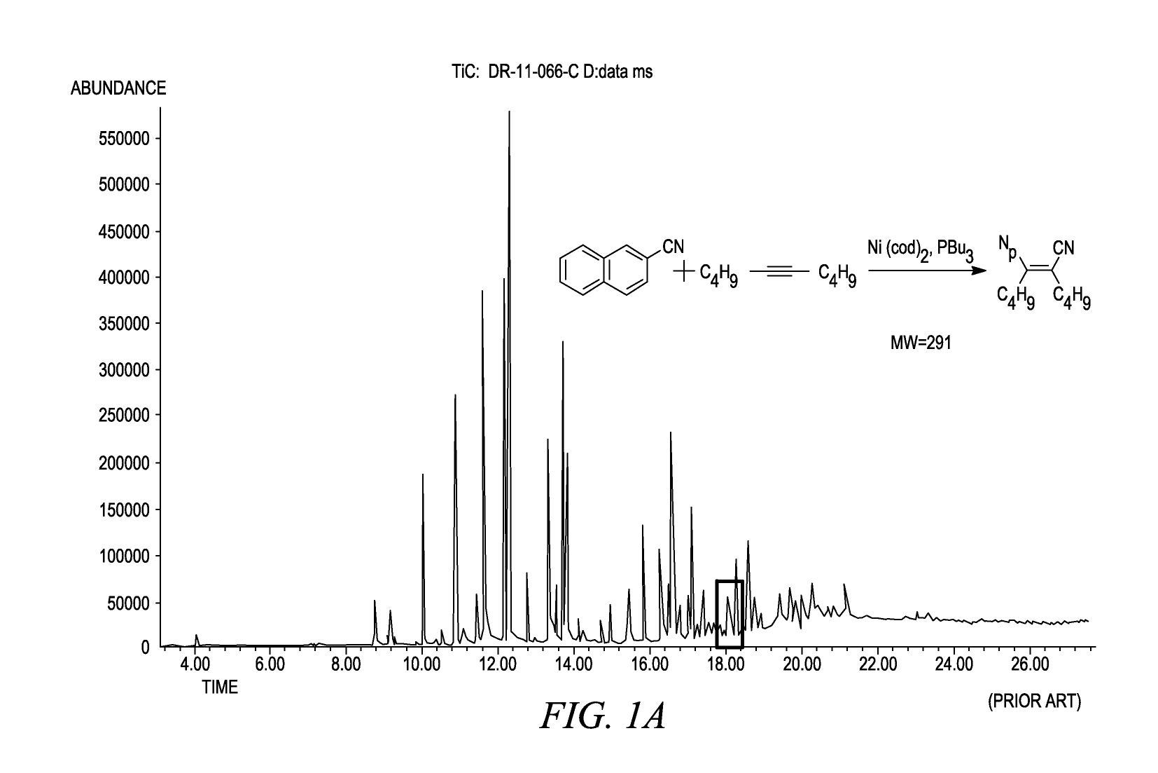

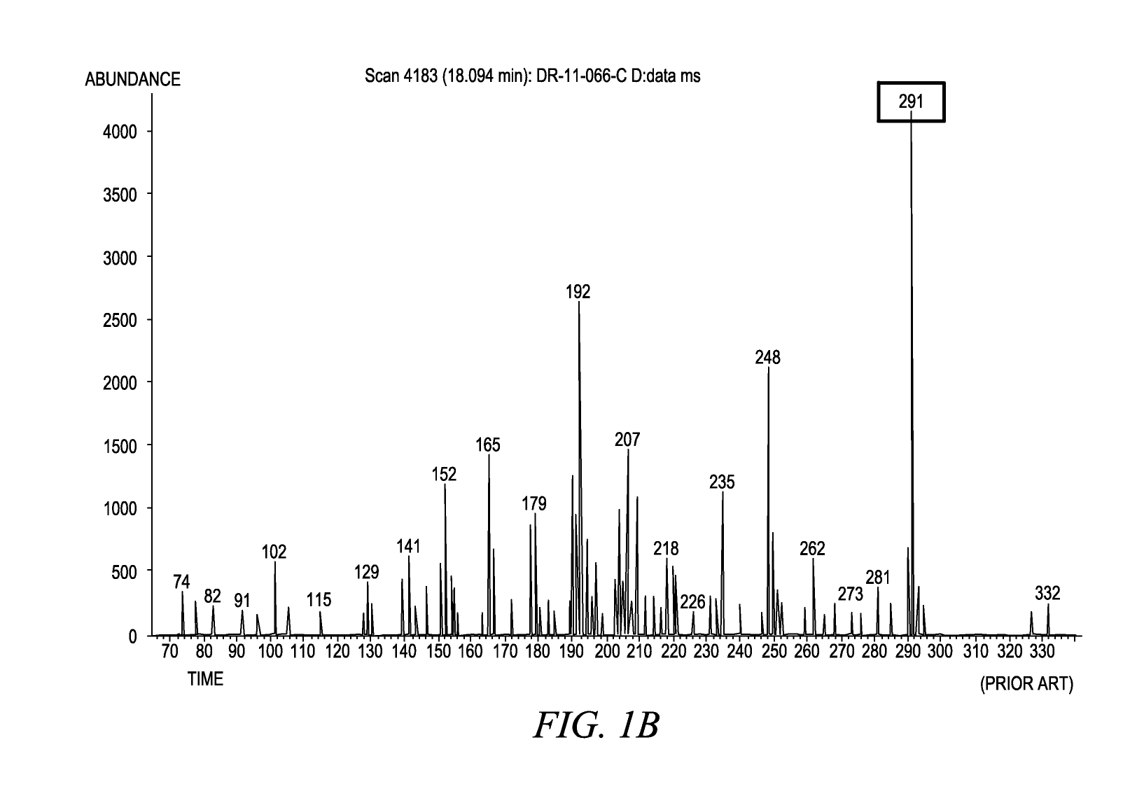

The experimental design was implemented by conducting experiments in which the 17 reagents were combined in each of 384 wells (of a 16×24 array), all but one well containing one metal precursor (15 total+one negative control containing no metal) and one ligand (23 ligands+one negative control containing no ligand). In this experiment, the substrates, metal-catalyst precursors, and ligands for three known reactions as positive controls were included. These reactions were the Ni-catalyzed carbocyanation of an alkyne (Nakao et al., J. Am. Chem. Soc. 126, 13904 (2004)), the Cu-catalyzed oxidative coupling of an aromatic amine and an aryl boronic acid (Lam et al., Tetrahedron Lett. 39, 2941 (1998)), and the Ru-catalyzed alkylation of a sulfonamide with an alcohol (Hamid et al., J. Am. Chem. Soc. 131, 1766 (2009)) (FIGS. 1, 2, and 3, respectively).

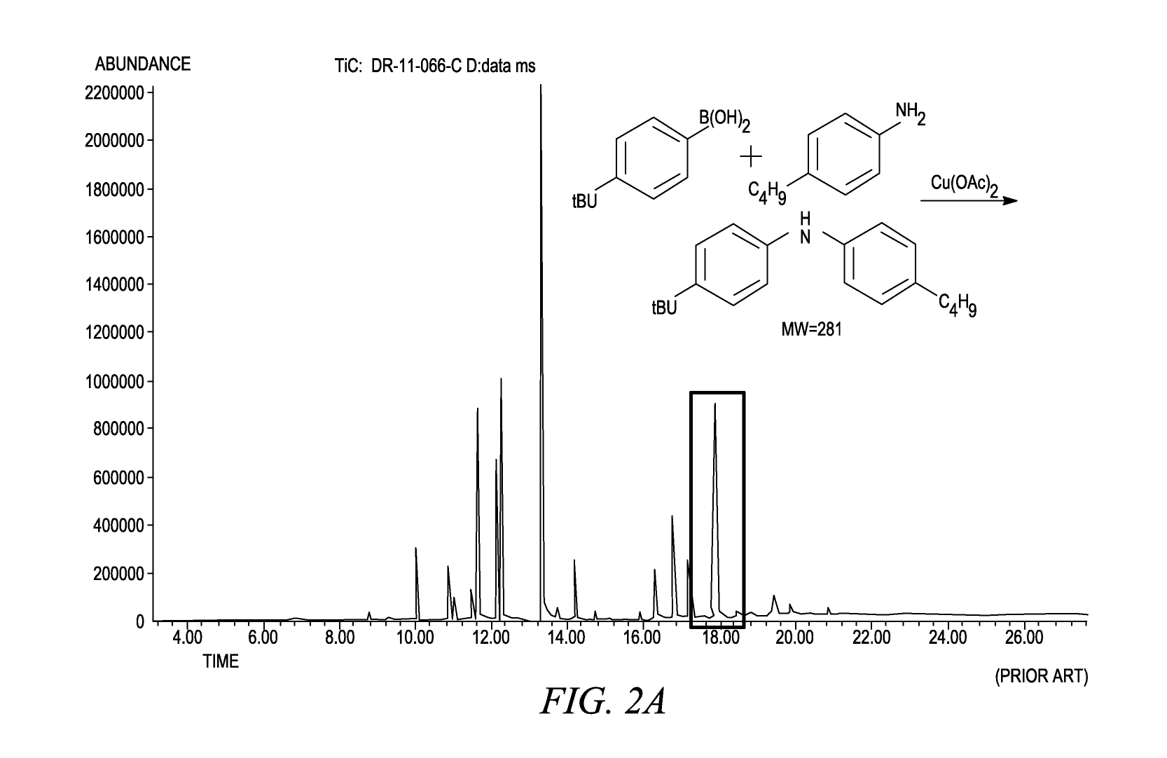

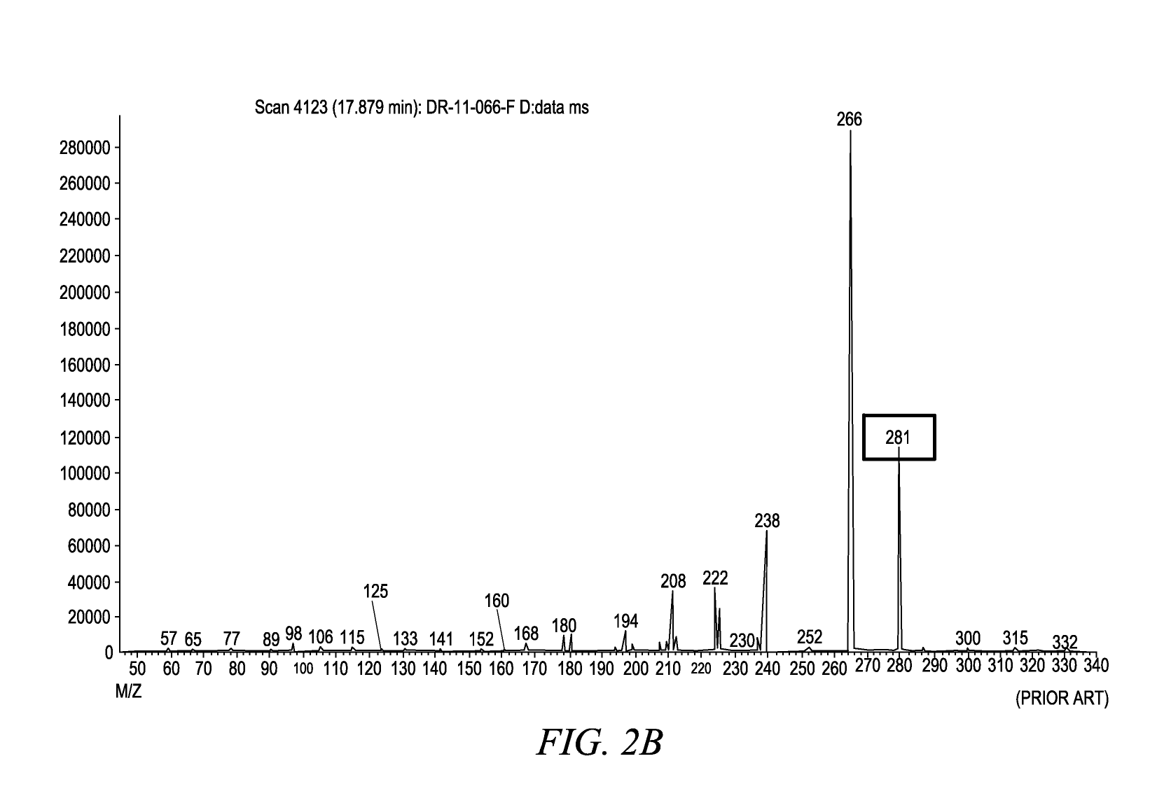

The product from each of these three reactions was observed among the more than 50,000 possible catalytic reactions [(17.16/2 cross combinations of substrates+17 homo-coupling of substrates)×15 metal catalyst precursors×24 ligands]. The GC-MS trace from the row containing Ni(cod)₂ revealed the product from carbocyanation of 5-decyne with 2-cyanonaphthalene, which eluted at 18.1 minutes and showed a molecular ion with an m/z value of 291 (FIG. 1). The GC-MS trace from the row containing Cu(OAc)₂ revealed the diarylamine obtained from oxidative coupling of 4-tert-butylphenylboronic acid with 4-butylaniline, which eluted at 17.9 minutes and showed a molecular ion with an m/z value of 281 (FIG. 2 and Scheme 2 below).

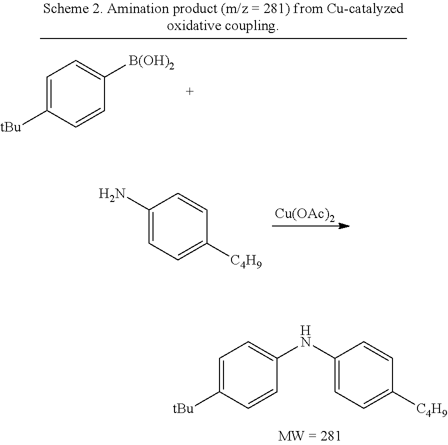

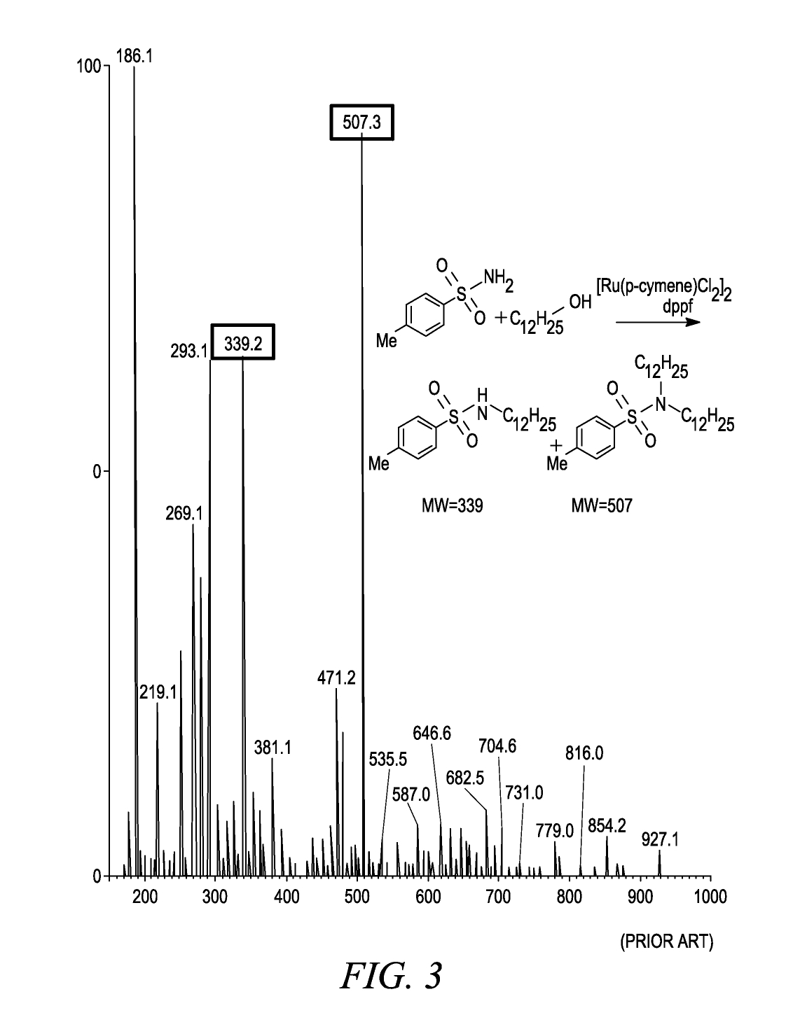

Finally, the ESI-MS for the row containing [Ru(p-cymene)Cl₂]₂ contained peaks corresponding to the mono- and dialkylation of p-toluenesulfonamide with 1-dodecanol with m/z=339 and m/z=507 (FIG. 3). These positive control experiments showed that discrete transition metal-catalyzed reactions could be identified from a pool of substrates that could undergo thousands of possible binary reactions.

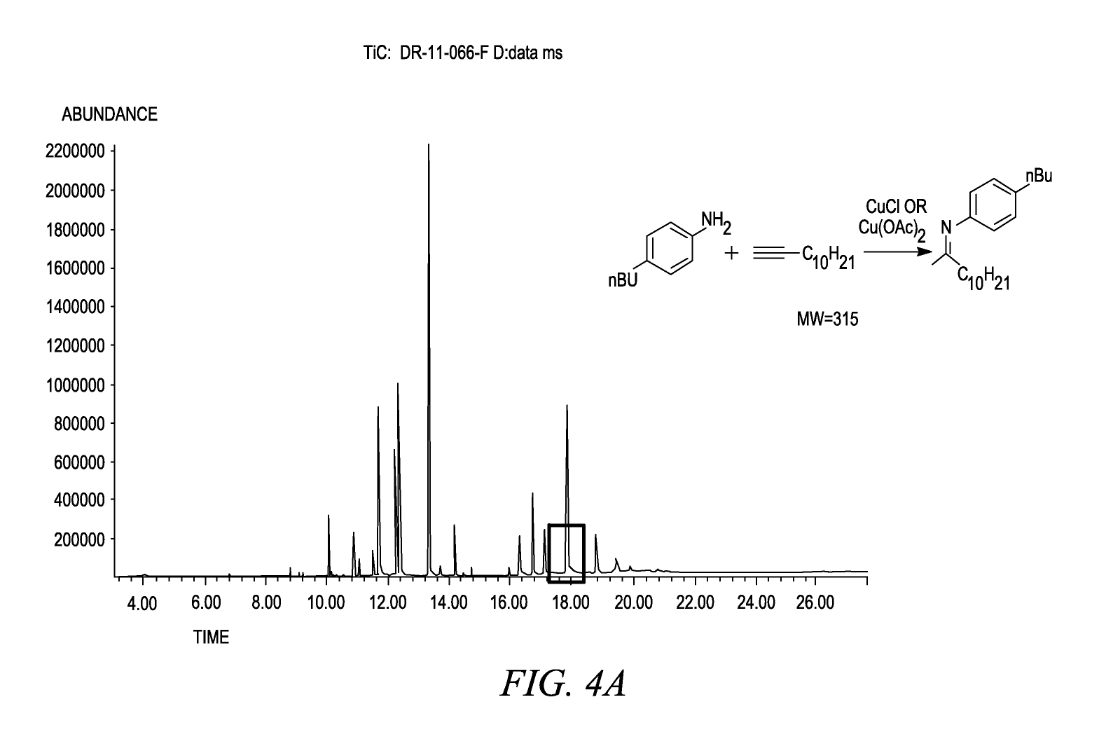

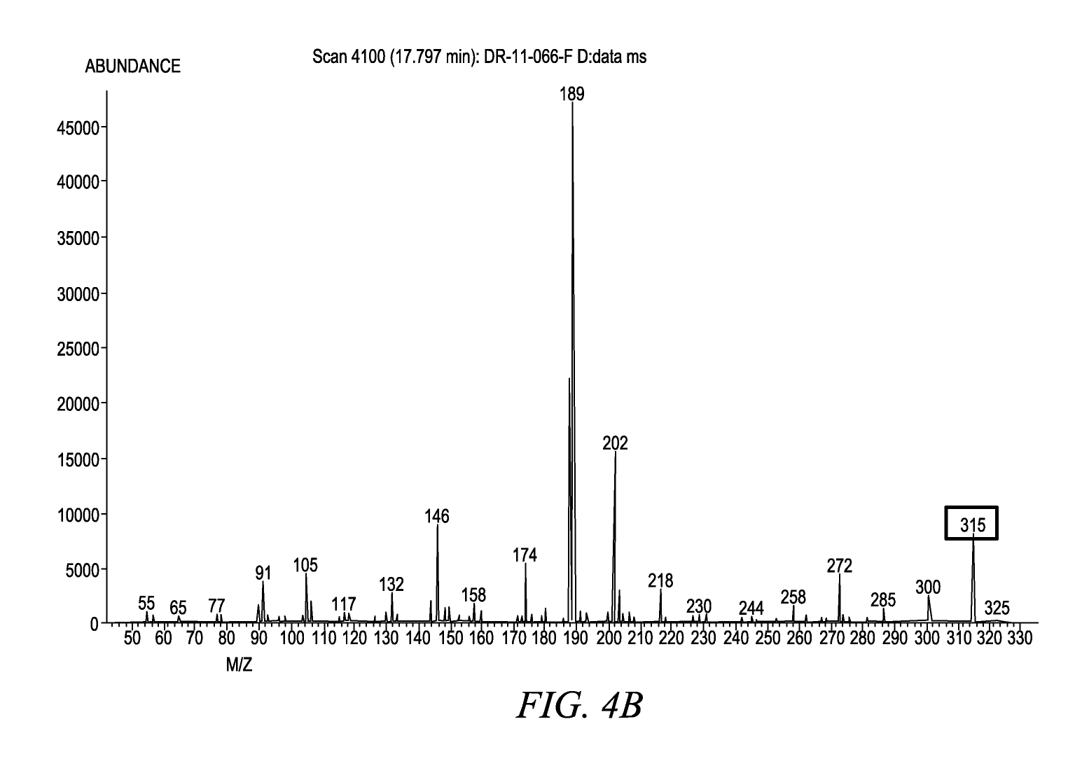

In addition to the products of these positive control reactions, products were observed from a reaction catalyzed by a first-row metal complex without ligand and a reaction catalyzed by a first-row metal complex containing a phosphine ligand. The GC-MS of the solutions in the two rows containing CuCl and Cu(OAc)₂ consisted of a peak with a molecular ion having m/z=315 (FIG. 4). This product corresponds to that from coupling of 1-dodecyne with 4-butylaniline. This peak also appeared in the GC-mass spectra of the contents of the rows corresponding to reactions containing PBu₃ (C), the f3-diketiminate ligand (L), and tri-p-tolylphosphite (S), as well as the row corresponding to reactions containing no ligand (T), indicating that the reaction occurs with the copper precursors alone and with the combination of the precursors and two of the phosphine ligands or the f3-diketiminate ligand.

Separate experiments with the amine, alkyne, and catalyst components alone demonstrated that the reaction of the aromatic amine with the alkyne catalyzed by CuCl or Cu(OAc)₂ leads to the Markovnikov addition of the amine to the alkyne, followed by tautomerization to the corresponding imine (Scheme 3). Intermolecular hydroamination of an alkyne has been reported with complexes of Group IV metals that are air sensitive and generally suffer from poor functional group compatibility, and it has been catalyzed by complexes of the precious metals palladium, rhodium and gold. Classical additions of amines to alkynes are conducted with toxic mercury compounds. For a review, see: Muller et al., Chem. Rev. 2008, 108, 3795. However, this is believed to be the first copper-catalyzed intermolecular hydroamination of an alkyne.

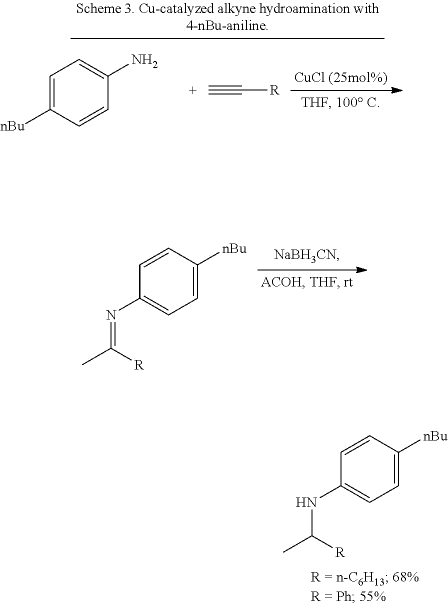

The products of these reactions were isolated as the secondary amine following reduction with NaBH₃CN. Reactions catalyzed by CuCl occurred in higher yield than those catalyzed by Cu(OAc)₂ (reactions catalyzed by Cu(OAc)₂ yielded substantial amounts of product from Glaser coupling of the alkynes to form a diyne). Although this reaction occurs in the presence of three of the ligands identified in the combinatorial format, the reaction also proceeded rapidly in the absence of ligand. This copper-catalyzed reaction represents a rare hydroamination of an alkyne catalyzed by a first-row metal, other than the air-sensitive titanocene systems (Zhou et al., Synlett 2009, 937 (2009); Zhou et al., Adv. Synth. Catal. 350, 2226 (2008)) and a single example with a zinc catalyst (Han et al., J. Am. Chem. Soc. 132, 916 (2009)). As shown by the data in Table 3, the copper-catalyzed reaction occurs smoothly under conditions with 25 mol % of the inexpensive CuCl in good yield and tolerates an array of potentially reactive functional groups, including nitriles, esters, ketones with enolizable hydrogens and unprotected alcohols, affirming the experimental design of the methods described herein.

TABLE 3
Selected Copper-Catalyzed Alkyne Hydroaminations with Aromatic
Amines.

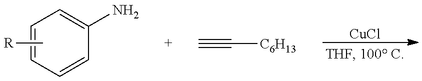

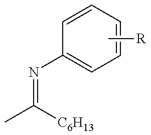

| Entry | R | Catalyst Loading | Yield* |
|---|---|---|---|
| 1 | 4-nBu | 10 mol % | 57% |
| 2 | 4-OH | 25 mol % | 80% |
| 3 | 4-CN | 25 mol % | 51% |
| 4 | 4-CO₂Me | 25 mol % | 68% |
| 5 | 3-Br | 25 mol % | 84% |
| 6 | 4-acetyl | 25 mol % | 60% |
| 7 | 2,6-di-isopropyl | 25 mol % | 70% |

*Yield determined by using gas chromatography with 1,3,5-trimethoxybenzene as an internal standard after hydrolysis with 1M HCl at room temperature to 2-octanone.

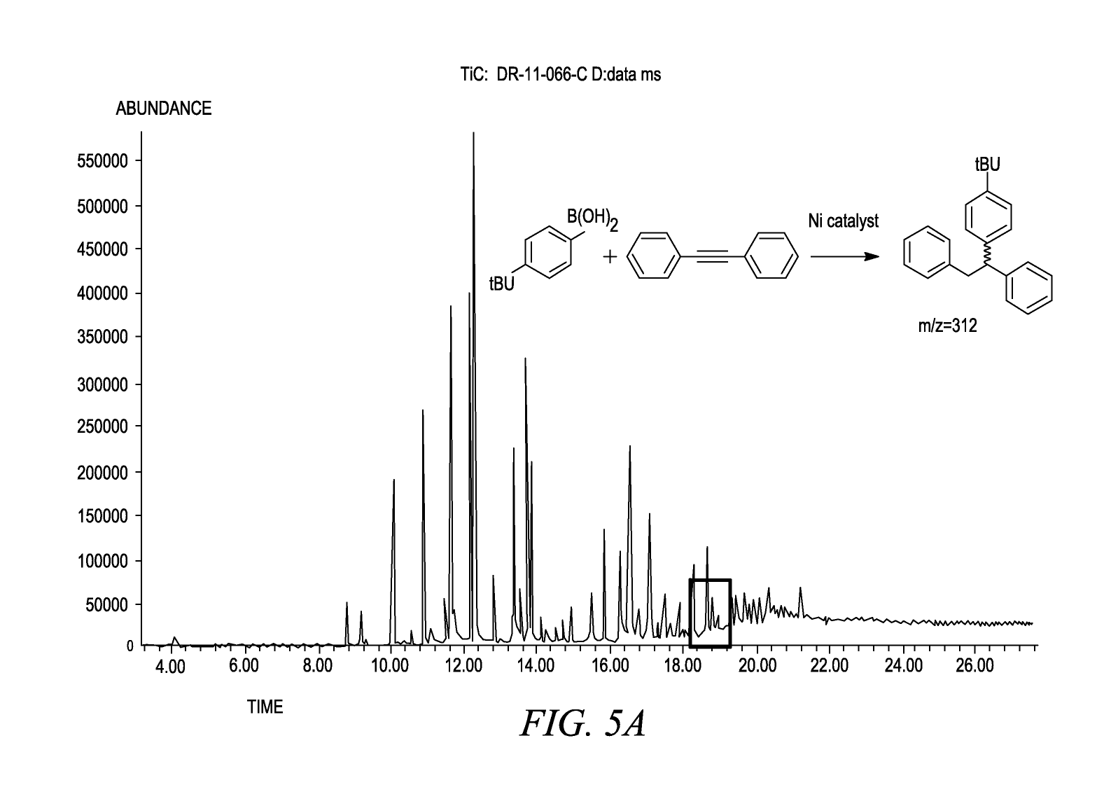

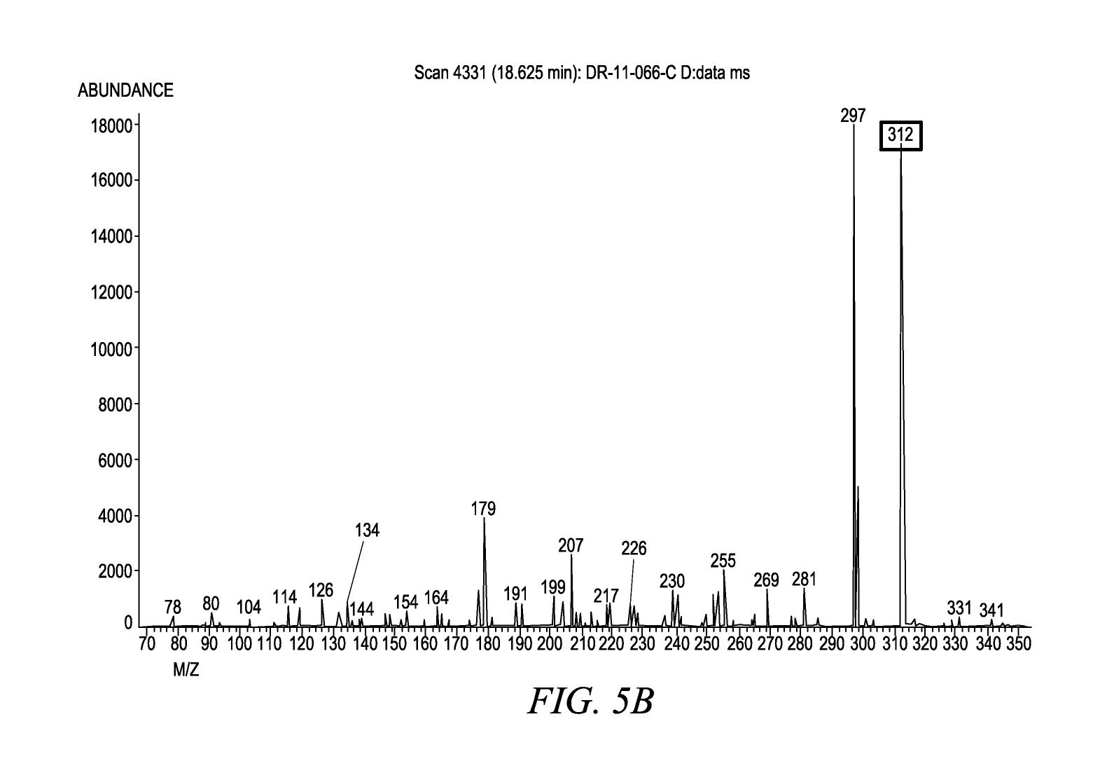

The GC-MS analysis from the experiment also revealed a reaction product eluting at 18.6 minutes with an apparent molecular ion having an m/z=312. This peak was observed in the traces of the wells containing the combination of Ni(cod)₂ (cod=1,4-cyclooctadiene) or NiCl₂-dme (dme=1,2-dimethoxyethane) and several phosphine ligands and an N-heterocyclic carbene (FIG. 5). Because the identity of this product was not obvious from the mass spectrum, a deconvolution strategy was devised to determine the reactants that formed the unidentified product.

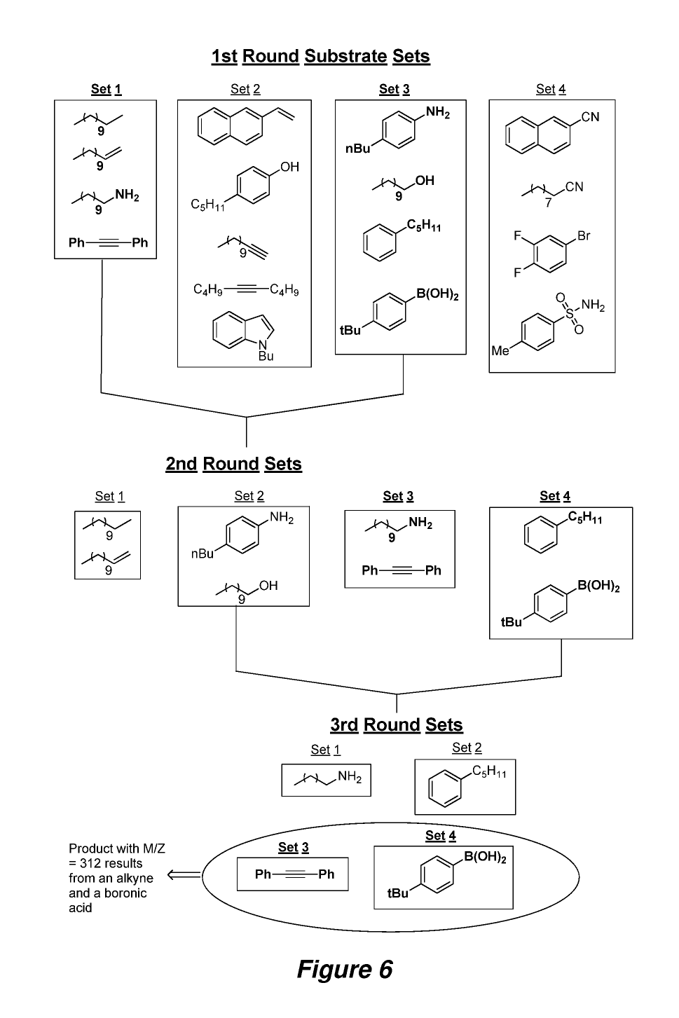

For this strategy, the potential reactants (in this case 17) were first divided into a small number of subsets, in this case three sets of four potential reactants and one set of five potential reactants (FIG. 6). The reactants in each of these sets were combined to create four pools of reactants. The pool of reactants in one set was then allowed to react with the three other pools in the presence of the metal catalyst precursor and ligand that had been shown to form the unidentified product. These binary combinations of the four sets of substrates corresponded to just six reactions. In addition, to assess whether the coupling of two of the reactants requires a third component that could act as a ligand or promoter, three of the substrate sets were also allowed, in parallel, to react in a similar manner, for a total of ten reactions. This set of ten reactions identified the two sets that contained the reactants that formed the unknown product.

The components of these two sets were then divided into four sets, each containing two substrates. In a similar manner, ten reactions were then conducted in parallel with the metal catalyst precursor and ligand, and the two sets that yielded the desired product were identified. The four individual components of these sets were then allowed to react with each other in binary and ternary combinations. From these reactions, the two reactants that formed the unknown product were identified (FIG. 6).

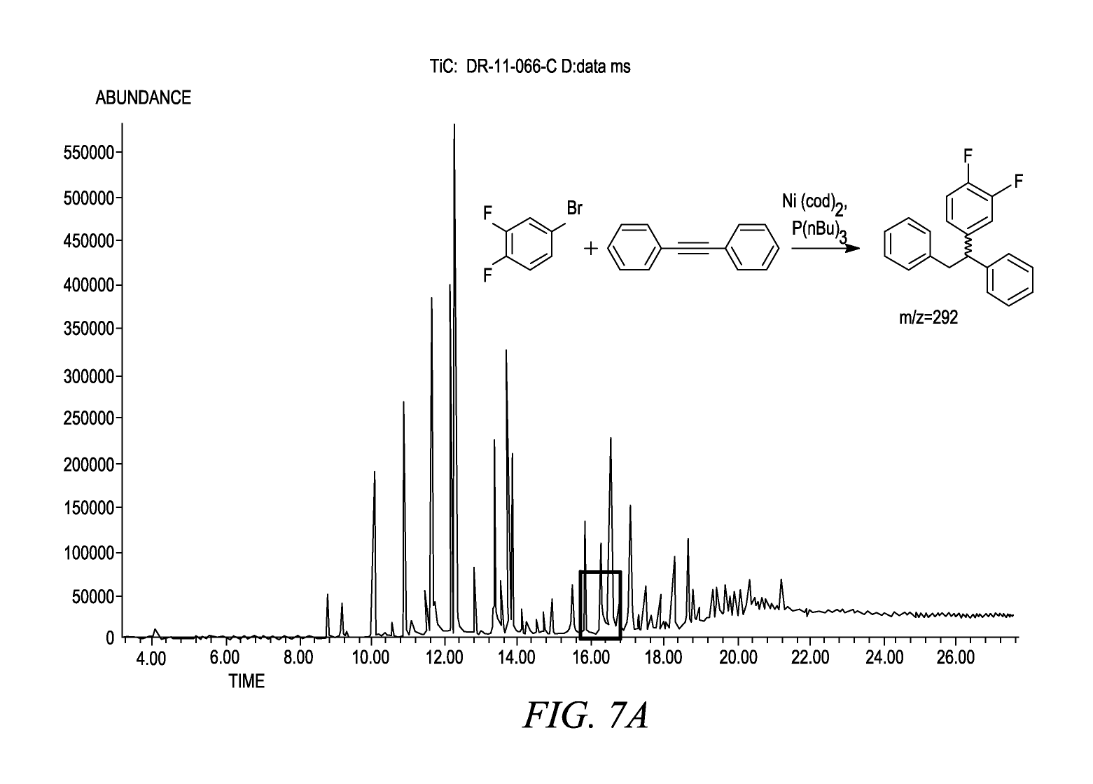

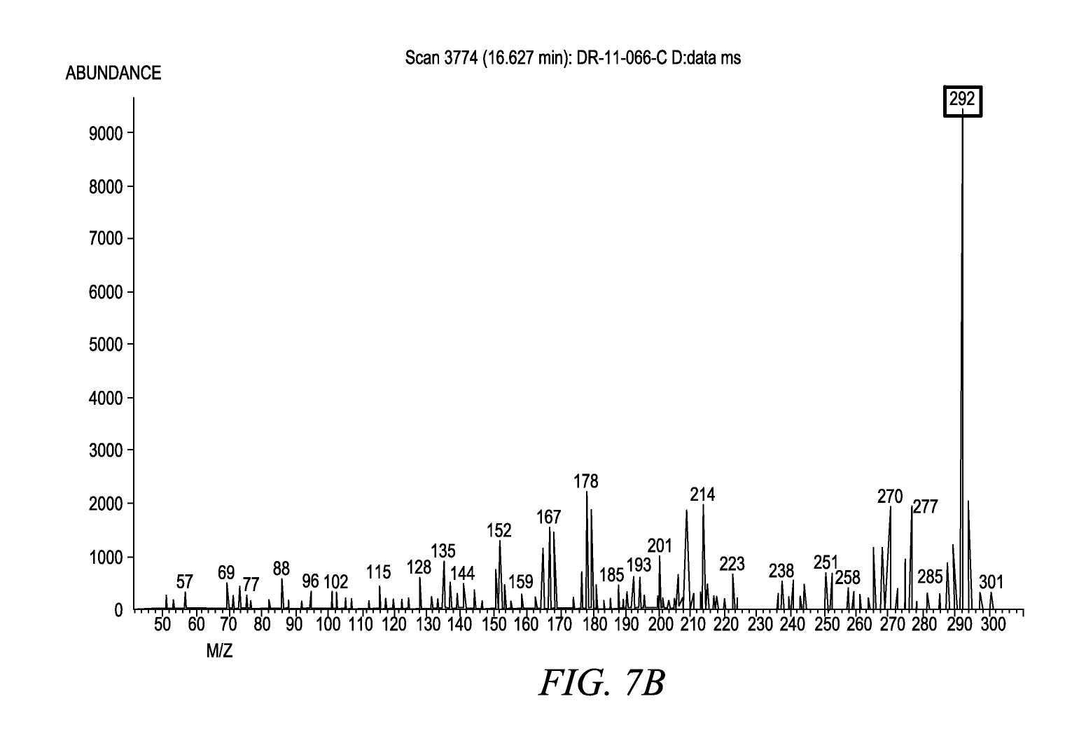

This short series of 3×10 reactions showed that the unknown product with m/z=312 corresponded to the hydroarylation of diphenylacetylene with 4-tert-butylphenylboronic acid to yield a triarylalkene product. A similar strategy showed that an additional product in the wells containing Ni(cod)₂ and P(nBu)₃ that eluted at 16.6 min with a molecular ion of m/z=292 (FIG. 7) corresponded to a triarylalkene product from hydroarylation of diphenylacetylene with the haloarene 4-bromo-1,2-difluorobenzene. Examination of the combinations of Ni(cod)₂ and NiCl₂-dme with the ligands identified from the initial catalyst screening showed that Ni(cod)₂ and PPh₃ catalyzed the hydroarylation of diphenylacetylene with phenylboronic acid to yield triphenylethylene in good yield (Scheme 4).

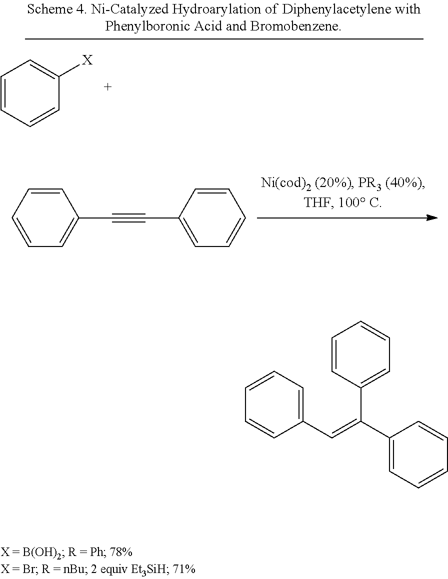

The reaction catalyzed by Ni(cod)₂ without added ligand formed just 15% yield of triphenylethylene. When the hydroarylation of diphenylacetylene was conducted with bromobenzene and the combination of Ni(cod)₂ and P(nBu)₃ as the catalyst, triphenylethylene was formed in less than 10% yield, but the same reaction with triethylsilane as a third component to act as a reducing agent furnished triphenylethylene in 71% yield (Scheme 4). This transformation of arylboronic acids has been reported most commonly with rhodium (Hayashi et al., J. Am. Chem. Soc. 123, 9918 (2001)) and palladium (Xu et al., Tetrahedron 66, 2433 (2010)) catalysts, which precious metals are exceedingly costly. For a single report describing a cobalt catalyst for an analogous process, see Lin et al., Chem. Eur. J. 14, 11296 (2008).

The synthesis of stereochemically defined trisubstituted alkenes is a challenging problem (Negishi et al., Acc. Chem. Res. 41, 1474 (2008); Negishi et al., J. Org. Chem. 75, 3151 (2010)). Stereochemically defined trisubstituted alkenes are often prepared by stereo-controlled additions to alkynes, but fewer reactions give anti-addition products than give syn-addition products, and hydroarylations that give anti addition products are unknown. In contrast to this precedent, the major products of the two types of nickel-catalyzed hydroarylation discovered here result from anti addition to the alkyne in most cases. For example, while an approximate 1:1 mixtures of stereoisomers was obtained from reaction of aryl boronic acids containing electron-donating substituents at the 4-position, the hydroarylation of diphenylacetylene with 4-tert-butylphenylboronic acid gave the addition product with an 8.7:1 ratio when the catalyst-ligand combination contained PPh₃. Likewise, the products from nickel catalyzed hydroarylation of an alkyne with the aryl halide and silane gave predominantly the anti-addition product.

Moreover, the ligand affects the E/Z ratio from reaction of the arylboronic acid. Reactions conducted with the catalyst generated from PCy₃ gave the addition product in a 1:3.8 ratio, favoring the stereoisomer from syn addition. These stereochemical outcomes were unexpected and show the ability to use the discovery platform to identify reactions that occur with different selectivities, presumably, from mechanisms not followed by prior catalysts.

A survey of this nickel-catalyzed hydroarylation of alkynes with various boronic acids (Scheme 5) showed that this reaction, like the hydroamination described above, tolerates a broad range of functional groups.

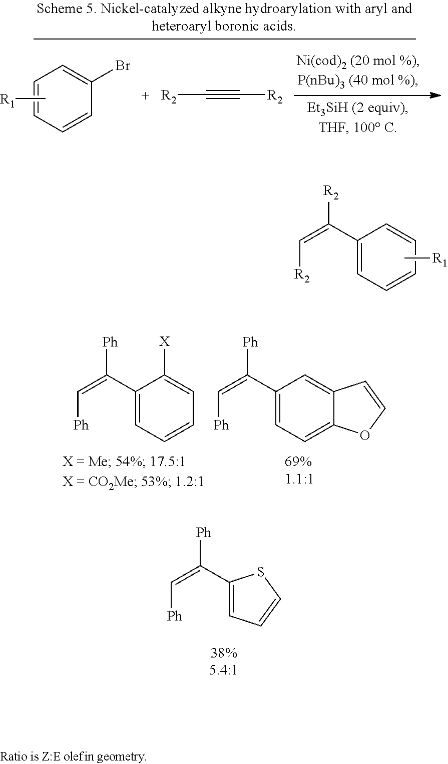

The nickel-catalyzed hydroarylation of alkynes with aromatic boronic acids containing esters, nitriles, ketones with enolizable hydrogens, aryl chlorides, and aldehydes formed trisubstituted alkenes in good yield with generally good selectivity for the Z over E alkene geometry. 2-Heteroaryl boronic acids, which are unstable in many reactions (see Knapp et al., J. Am. Chem. Soc. 131, 6961 (2009); Kinzel et al., J. Am. Chem. Soc. 132, 14073 (2010)), also underwent this process to form the corresponding product from trans hydroheteroarylation of diphenylacetylene. Reaction of a heteroaryl boronic acid with an internal alkyne possessing alkyl substituents also formed the product of hydroheteroarylation. Selected examples of the second type of alkyne hydroarylation discovered involving aryl halides and triethylsilane are shown in Scheme 6.

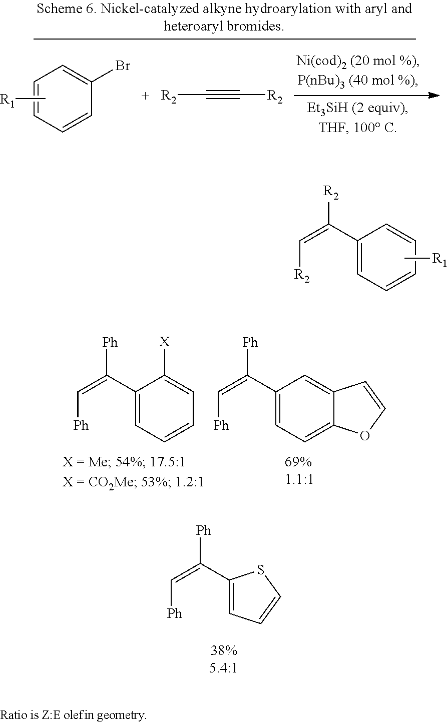

While additional studies can be used to further identify the most effective combination of catalyst and reducing agent, these current studies show that the reactions of aryl halides containing potentially reactive functional groups, as well as heteroaryl halides, form the trisubstituted alkenes with good to moderate selectivity for the product from formal trans addition.

The approach to reaction discovery described herein can be used for identifying reactions that are facilitated by the presence of additional components or for identifying particular reaction attributes. For example, this system can be used to explore reactions with additives, such as oxidants, reductants, acids, and/or bases, and/or to explore reactions of two substrates with a third component, for example a small molecule additive such as carbon monoxide, carbon dioxide, and the like. It can also be used to examine the reactivity of a single ligand class with various organic substrates and transition metal catalyst precursors. Thus, this approach to reaction discovery provides a general and adaptable platform suitable for use by a wide range of laboratories for the discovery of a variety of catalytic reactions.

Methods.

All reactions were conducted under an argon or nitrogen atmosphere in flame-dried glassware or in an Innovative Technologies drybox. Dry and degassed solvents were used unless otherwise noted. Column chromatography was performed with a Teledyne Isco Combiflash® R_{f} system with RediSep R_{f} columns.

Materials.

Fe(acac)₂, MoCl₅, CuCl, FeCl₃, NiCl₂-dme Mn(acac)₂, (benzene)Cr(CO)₃, Co(OAc)₂, Yb(OAc)₃, W(CO)₃(MeCN)₃, PPh₃, PnBu₃, PCy₃, 2-aminocyclohexanol HCl, ethanolamine, 2-picolinic acid, 4,4′-di-tert-butylbipyridine, TMEDA, trans-1,2-diaminocyclohexane, BINOL, cis,cis-1,5-cyclooctadiene (cod), 2,2,6,6-tetramethylheptane-3,5-dione, diphenylphosphine oxide, L-proline, dodecane, 1-dodecene, 1-dodecanol, 1-dodecylamine, p-toluenesulfonamide, 4-bromo-1,2-difluorobenzene, 4-pentylphenol, 2-cyanonaphthalene, diphenylacetylene, triethylsilane, triethylamine, NaOt-Bu, 1-octyne, NaBH₃CN, AcOH, DMF, indole and 1-iodobutane were purchased from Aldrich Chemicals and used as received. Ni(cod)₂, [Ru(p-cymene)Cl₂]₂, Cu(OAc)₂ (anhydrous), Mo(CO)₃(EtCN)₃, AuCl, 1,1′-Bis(diphenylphosphino)ferrocene, and Monophos were purchased from Strem

Chemicals and used as received. 1-Dodecyne, decanonitrile, n-pentylbenzene, 2-vinylnaphthalene, and 5-decyne were purchased from Alfa Aesar and used as received. 4-n-Bu-aniline was purchased from TCI America and used as received. Aryl and heteroaryl boronic acids were purchased from CombiBlocks and used as received. N—((Z)-4-(Phenylamino)pent-3-en-2-ylidene)aniline, (Tang et al., J. Organomet. Chem. 691, 2023 (2006)) methylenebis(diphenylphosphine oxide) (Sutton et al., Inorg. Chem. 43, 5480 (2004)), and methylenebis(diphenylphosphine sulfide) (Cantat et al., Organometallics 25, 4965 (2006)) were prepared by literature methods. NaH was purchased from Aldrich Chemicals as a 60% dispersion in mineral oil, washed with pentane and dried under vacuum before use. 2-1,2-Diphenylethenyl tosylate was prepared according to a literature report (Klapars, et al., Org. Lett. 7, 1185 (2005)).

Instruments.

GC-MS data were obtained on an Agilient 6890-N GC system containing an Alltech EC-1 capillary column and an Agilient 5973 mass selective detector. ESI-MS data were obtained with a Waters ZMD Quadropole Instrument with a photomultiplier detection system and a 1:1 MeCN:H₂O mobile phase.

### Experimental Procedures and Information.

Synthesis of N-Bu-indole.

Inside a glovebox, indole (1.17 g, 10.0 mmol, 1.00 equiv), NaH (240 mg, 10.0 mmol, 1.00 equiv) and dry DMF (10 mL) were mixed in a dry vial at room temperature for 2 h. After 2 h, 1-iodobutane (2.03 g, 11.0 mmol, 1.10 equiv) was added, and the vial was heated at 100° C. for 2 h. After 2 h, the mixture was cooled to room temperature, filtered through silica gel washing with EtOAc, and the resulting solution was concentrated under vacuum. The residue was purified by flash column chromatography (0-5% EtOAc in hexanes) to give pure N-Bu-indole (951 mg, 55%). Spectral properties matched those of previous reports containing the preparation of this compound (Le et al., Synthesis 2004, 208 (2004)).

Assembly of 96-Well Plates for High-Throughput Discovery.

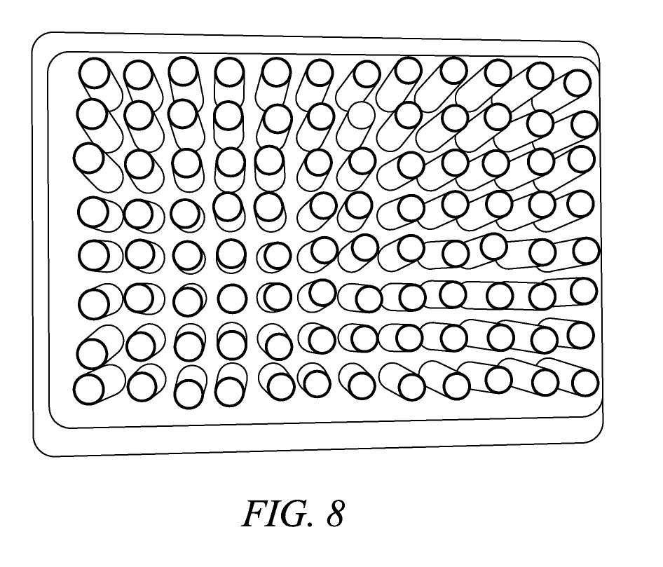

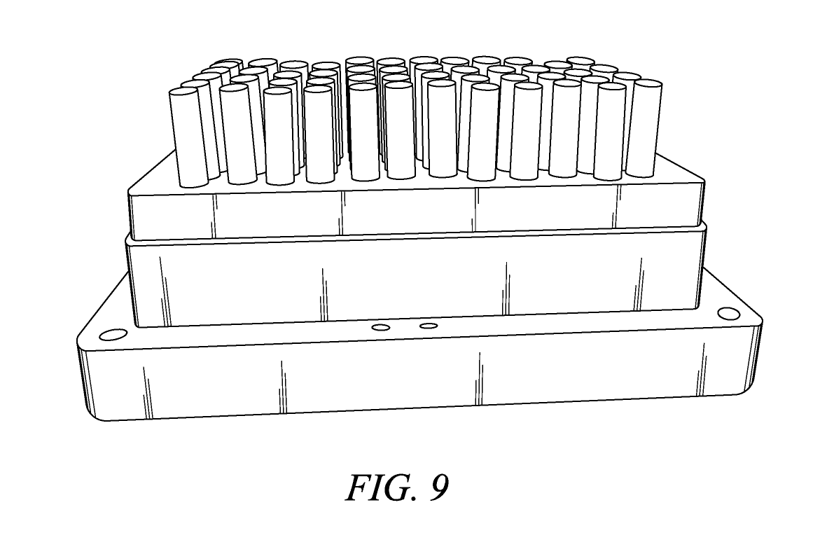

An aluminum 96-well plate (FIGS. 8-10) was filled with ˜1 mL glass tubes (Kimble Reusable Borosilicate Glass Tubes with Plain End O.D.×L: 6×50 mm; available from Fisher Scientific), dried in an oven and brought into a nitrogen-filled glovebox. Stock solutions of each metal catalyst precursor were prepared with the following masses of each metal and 1.2 or 2.4 mL of THF.

TABLE 4

| Metal Catalyst Precursor | Mass per Well (mg) | Total Mass (mg) |
|---|---|---|
| 1) Fe(acac)₂ | 3.8 | 45.8 |
| 2) MoCl₅ | 4.0 | 48 |
| 3) Ni(cod)₂ | 4.2 | 49.6 |
| 4) [Ru(p-cymene)Cl₂]₂ | 4.6 | 55.2 |
| 5) CuCl | 1.6 | 19.2 |
| 6) Cu(OAc)₂ | 2.8 | 32.8 |
| 7) FeCl₃ | 4.6 | 56.2 |
| 8) NiCl₂-dme | 3.3 | 39.6 |
| 9) Mn(acac)₂ | 3.8 | 45.6 |
| 10) Co(OAc)₂ | 2.7 | 31.9 |
| 11) AuCl | 3.5 | 41.9 |
| 12) (benzene)Cr(CO)₃ | 3.3 | 38.5 |
| 13) W(CO)₃(MeCN)₃ | 5.9 | 70.4 |
| 14) Yb(OAc)₃ | 5.3 | 63.1 |
| 15) Mo(CO)₃(EtCN)₃ | 5.2 | 62.2 |
| 16) None | — | — |

The metal catalyst precursors were then added to the tubes in the plate by adding 0.1 mL (1.2 mL stock solution) or 0.2 mL (2.4 mL stock solution) to each tube of the appropriate row. Metal catalyst precursors that were not soluble (3, 5-8, 10, 14) were added individually to the appropriate tubes.

Stock solutions of each ligand (see Table 2 and the table below for structures) were prepared with 0.8 mL or 1.6 mL of THF and the masses of the ligands shown below in Table 5.

TABLE 5

| | | Mass | Total |
|---|---|---|---|
| | | per Well | Mass |
| Ligand | | (mg) | (mg) |
| A) | PPh₃ | 7.8 | 62.8 |
| B) | PCy₃ | 8.4 | 67.2 |
| C) | PnBu₃ | 6.1 | 48.8 |
| D) | dppf [1,1′-bis(diphenylphosphino)ferrocene] | 8.4 | 67.2 |
| E) | 2-aminocyclohexanol HCl | 2.2 | 18.2 |
| F) | Ethanolamine | 1.0 | 8.0 |
| G) | 2-picolinic acid* | 1.8 | 14.8 |
| H) | N,N′-diphenylbenzimidamide* | 4.1 | 32.8 |
| I) | Trans-1,2-diaminocyclohexane | 1.8 | 14.4 |
| J) | TMEDA | 1.8 | 14.4 |
| K) | Tetramethylheptanedione* | 2.8 | 22.4 |
| L) | N-((Z)-4-(phenylamino)pent-3-en-2- | 3.8 | 30.4 |
| | ylidene)aniline* | | |
| M) | L-proline* | 1.8 | 14.4 |
| N) | Methylenebis(diphenylphosphine oxide)* | 6.3 | 50.4 |
| O) | Methylenebis(diphenylphosphine sulfide)* | 6.8 | 54.4 |
| P) | Diphenylphosphine oxide | 6.1 | 48.8 |
| Q) | SIPr-HCl* | 6.4 | 51.2 |
| R) | Cod (cyclooctadiene) | 3.2 | 25.6 |
| S) | P(O-p-tol)₃ | 10.6 | 84.8 |
| T) | None | — | — |
| U) | Monophos [(3,5-Dioxa-4-phospha- | 5.4 | 43.2 |
| | cyclohepta[2,1-a; 3,4-a′]dinaphthalen-4- | | |
| | yl)dimethylamine] | | |
| V) | BINOL | 4.2 | 34.4 |
| W) | dtbpy (4,4′-di-tert-butylbipyridine) | 4.0 | 32 |
| X) | (N,N′E,N,N′E)—N,N′-(ethane-1,2- | 5.6 | 45.2 |
| | diylidene)bis(2,6-diisopropylaniline) | | |

The ligands were then added to the tubes in the plate by adding 0.1 mL (0.8 mL stock solution) or 0.2 mL (1.6 mL stock solution) to each tube of the appropriate row. Ligands that were not soluble (D, E, G, M, N, O, Q) were added individually to the appropriate tubes. To the tubes containing ligand precursors that were activated with base (*), 2 mg of NaOt-Bu was added as a solution in dry THF. The plate with the tubes containing the metal catalyst precursors and ligands were then heated at 40-50° C. inside the glove box to evaporate the solvent.

To an oven-dried 25 mL volumetric flask was added the following masses (Table 6) of each substrate.

TABLE 6

| | | Mass per Well |
|---|---|---|
| | Total Mass | (mg) after dispensing |
| Substrate | (mg) | the stock solution |
| Dodecane | 245 | 2.6 |
| 1-dodecene | 242 | 2.5 |
| 1-dodecyne | 240 | 2.5 |
| 1-dodecanol | 268 | 2.8 |
| 1-dodecylamine | 267 | 2.8 |
| Decanonitrile | 221 | 2.3 |
| 4-bromo-1,2-difluorobenzene | 278 | 2.9 |
| 2-vinylnaphthalene | 222 | 2.3 |
| p-toluenesulfonamide | 247 | 2.6 |
| Diphenylacetylene | 257 | 2.7 |
| 4-n-pentylphenol | 237 | 2.5 |
| 2-cyanonaphthalene | 221 | 2.3 |
| 4-tert-butylphenylboronic acid | 257 | 2.7 |
| 5-decyne | 200 | 2.1 |
| n-pentylbenzene | 214 | 2.2 |
| 4-n-Bu-aniline | 215 | 2.2 |
| N—Bu-indole | 250 | 2.6 |

Following addition of the substrates to the volumetric flask, the mixture was diluted with dry THF to a volume of 25 mL. This solution was then transferred to a separate dry glass container, and the volumetric flask was washed with an additional 4 mL of THF for a total volume of 29 mL. A 0.3 mL aliquot of this solution was then added to each of the 96 tubes in the plate (29 mL/96 wells=0.30 mL/well). The plate containing the glass tubes was then heated at 40-50° C. inside the glove box to evaporate the solvent.

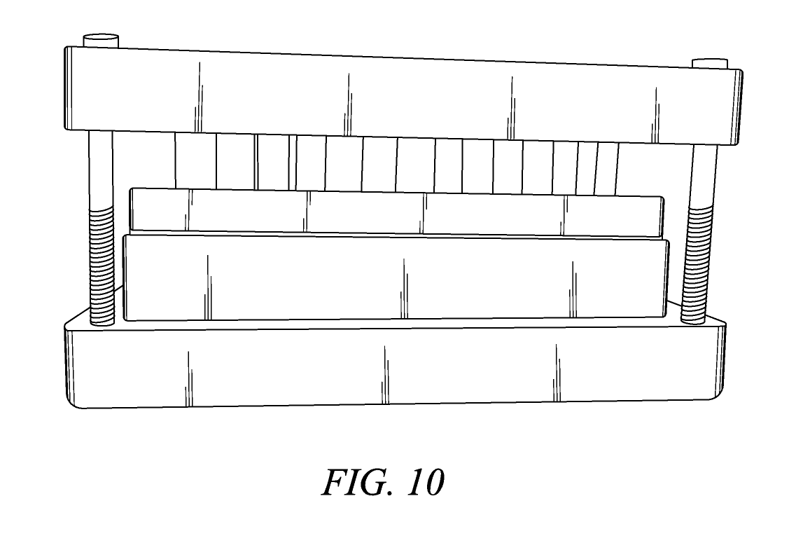

After evaporation of the solvent, the well plate was sealed by placing a sheet of Teflon® over the glass tubes and placing a smooth metal plate on top of the well plate. The top plate was fixed into place with bolts tightened with a torque wrench. This sealed well plate was then heated on a standard heating plate for 18 h at 100° C. (see FIG. 10).

Combining the Post-Reaction Mixtures into a Group of Twenty Samples.

Following heating, the reaction assembly was removed from the heating plate and cooled to room temperature. After cooling, the assembly was removed from the glove box. A set of eight 4 mL vials was labeled A, B, C, D, E, F, G, and H for each of the 8 rows in the well plate. A set of 12 4 mL vials was labeled 1, 2, 3, 4, 5, 6, 7, 8, 9, 10, 11, and 12 for each of the columns in the well plate, making a total of 20 vials. 0.5 mL of CH₂Cl₂ was added to each of the 96 glass tubes, and 2 samples were removed from each glass tube: one sample was placed in the 4 mL vial corresponding to the row and one sample was placed in the 4 mL vial corresponding to the column.

For example, a sample from tube A1 was placed in both vial A and vial 1. After this distribution of aliquots was completed for each of the 96 glass tubes, the contents of the 20 4 mL vials labeled A-H and 1-12 was filtered through a plug of Celite in a pipette into a GC vial, and was washed with ethyl acetate. These vials were analyzed by GC-MS. A sample was removed from each of the samples for GC-MS analysis, placed into a separate GC vial, and diluted with MeOH. These samples were analyzed by ESI-MS.

Reaction Analysis.

Following analysis of each of these samples by GC-MS and ESI-MS, the mass spectral data were analyzed. In each of the GC-MS chromatograms, the organic substrates eluted between 0 and 13.5 minutes. The masses of peaks for material eluting between 13.5 minutes and the end of the GC-MS method were determined. In the ESI-mass spectra, significant peaks in the appropriate mass range for the reaction of two of the organic substrates were identified. After the mass(es) of product(s) had been determined by MS analysis, a spreadsheet containing potential product masses was used to identify the possible combinations of substrates that could form a product with the observed mass. A search for the product mass was conducted using Microsoft Excel. When two potential reactive substrates were identified, two independent reactions were conducted: one reaction with the two substrates (0.05 mmol each), the metal catalyst precursor (0.05 mmol) and THF (0.1 mL) and one reaction with the two substrates (0.05 mmol each), the metal catalyst precursor (0.05 mmol), the ligand (0.05 mmol) and THF (0.1 mL). These independent reactions were then assayed by GC-MS or ESI-MS to confirm the assignment of the reaction components leading to the observed product.

Reaction Deconvolution Scheme for Identification of the Product of the Hydroarylation of Diphenylacetylene with 4-tert-butylphenylboronic Acid.

To determine the two substrates that led to the observed reaction product when the identity of the product was at least initially indeterminable from the mass spectrum, the following deconvolution scheme was followed. This scheme can be used generally to find the two reactants that lead to any observed product. First, the 17 substrates used in the high-throughput reaction discovery system were divided into 4 groups, as shown in Scheme 7 below.

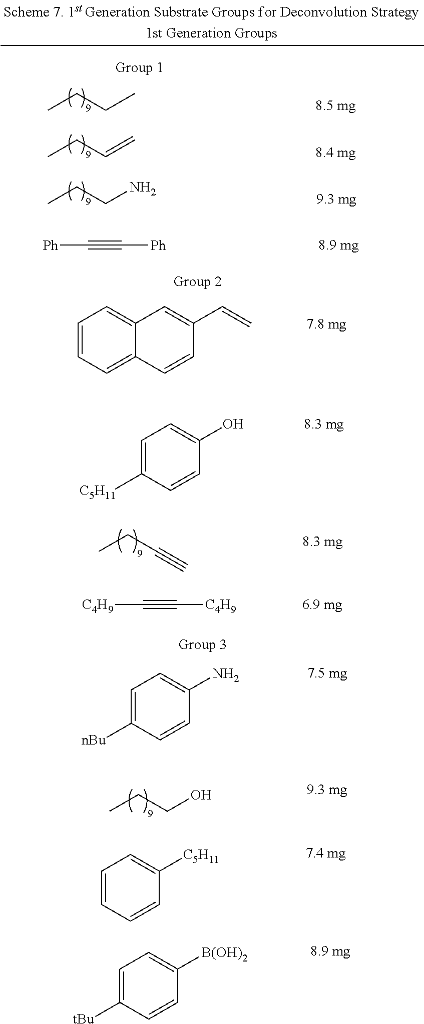

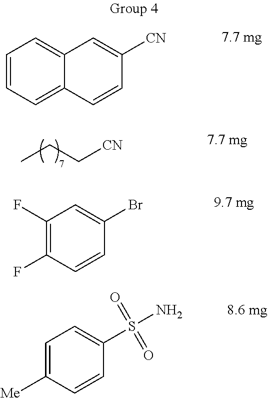

A set of 10 reactions was then assembled. Ni(cod)₂ (6.9 mg, 0.025 mmol), PPh₃ (13.1 mg, 0.05 mmol), the substrates (the dmasses of which are shown in Table 7 below) and THF (0.2 mL) were added to a dry vial containing a magnetic stir bar. The vial was sealed, removed from the glove box, and heated at 100° C. for 18 h. After heating, the reaction mixture was cooled to room temperature and analyzed by GC-MS. Each reaction was then evaluated to determine if it contained the product observed during the catalyst screening.

TABLE 7

| | | Product Detected |
|---|---|---|
| Reaction # | Substrate Groups | by GC-MS? |
| 1 | 1, 2 | No |
| 2 | 1, 3 | Yes |
| 3 | 1, 4 | No |
| 4 | 2, 3 | No |
| 5 | 2, 4 | No |
| 6 | 3, 4 | No |
| 7 | 1, 2, 3 | Yes |
| 8 | 1, 2, 4 | No |
| 9 | 1, 3, 4 | Yes |
| 10 | 2, 3, 4 | No |

From these results, it was determined that the reaction occurred between a substrate from Group 1 and a substrate from Group 3. The substrates in Group 1 and Group 3 were then divided into 4 2^{nd} generation groups shown in Scheme 8 below.

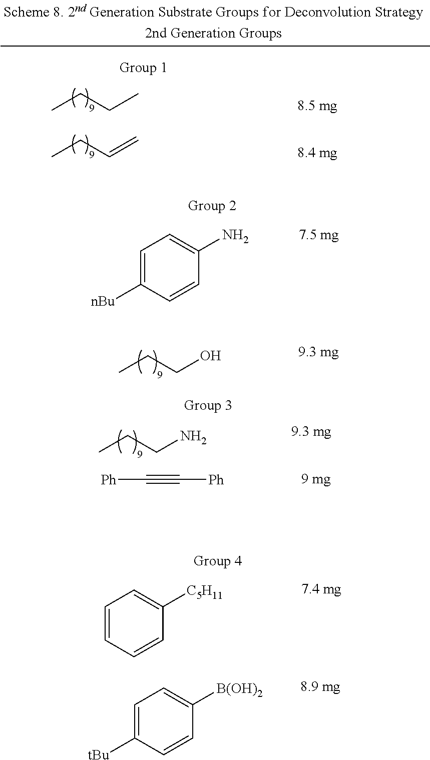

The same set of reactions with the same catalyst loading, temperature and time was then performed with these substrate groups. The results are shown in Table 8 below.

TABLE 8

| | | Product Detected |
|---|---|---|
| Reaction # | Substrate Groups | by GC-MS? |
| 1 | 1, 2 | No |
| 2 | 1, 3 | No |
| 3 | 1, 4 | No |
| 4 | 2, 3 | No |
| 5 | 2, 4 | No |
| 6 | 3, 4 | Yes |
| 7 | 1, 2, 3 | No |
| 8 | 1, 2, 4 | No |
| 9 | 1, 3, 4 | Yes |
| 10 | 2, 3, 4 | Yes |

From these results, it was determined that the reaction occurred between a substrate from Group 3 and a substrate from Group 4. The substrates in Group 3 and Group 4 were then divided into four groups shown below in Scheme 9.

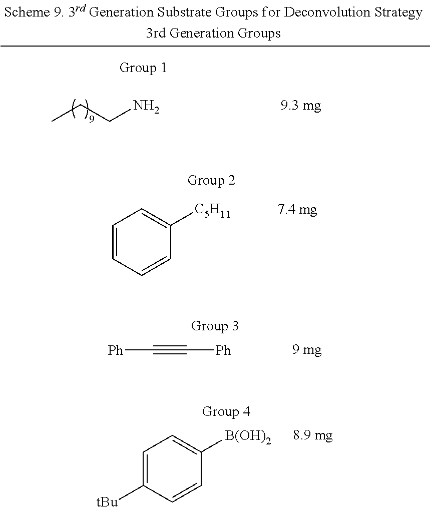

The same set of reactions with the same catalyst loading, temperature and time was then performed with all binary and ternary combinations of the four substrates in the two second generation groups that led to product. The results are shown in Table 9 below.

TABLE 9

| | | Product Detected |
|---|---|---|
| Reaction # | Reactant | by GC-MS? |
| 1 | 1, 2 | No |
| 2 | 1, 3 | No |
| 3 | 1, 4 | No |
| 4 | 2, 3 | No |
| 5 | 2, 4 | No |
| 6 | 3, 4 | Yes |
| 7 | 1, 2, 3 | No |
| 8 | 1, 2, 4 | No |
| 9 | 1, 3, 4 | Yes |
| 10 | 2, 3, 4 | Yes |

From these results, it was determined that the product was formed from Reactant 3 (diphenylacetylene) and Reactant 4 (4-tert-butylphenylboronic acid). An independent reaction with phenylboronic acid and diphenylacetylene catalyzed by 20% Ni(cod)₂ and 40% PPh₃ in THF formed triphenylethylene in 78% yield, as determined by GC and GC-MS, confirming the assignment of reactants leading to the product.

### Hydroamination Examples

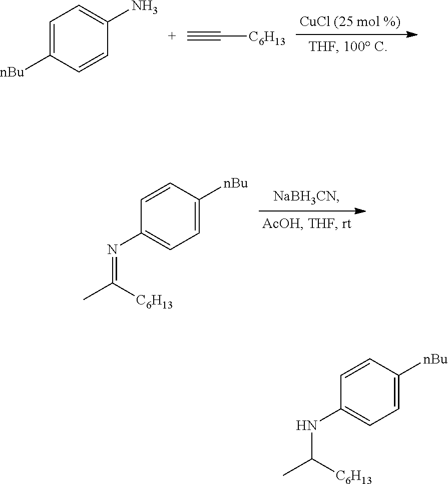

One-Pot Alkyne Hydroamination and Reduction with 4-n-Bu-aniline and 1-octyne.

Inside a glove box, CuCl (24.9 mg, 0.250 mmol, 0.250 equiv), 4-nBu-aniline (224 mg, 1.50 mmol, 1.50 equiv), 1-octyne (110 mg, 1.00 mmol, 1.00 equiv), and dry THF (2 mL) were added to a dry vial containing a magnetic stir bar. The vial was sealed, removed from the glove box, and heated at 100° C. for 16 h. After heating, the reaction mixture was cooled to room temperature and analyzed by GC-MS. After full conversion of the alkyne was observed, NaBH₃CN (189 mg, 3.00 mmol, 3.00 equiv) and 2 mL THF were added to the reaction mixture. The reaction mixture was cooled to 0° C. with an ice bath. AcOH (0.6 mL, 10 mmol, 10 equiv) was added dropwise to the reaction mixture. The ice bath was removed, and the reaction was allowed to warm gradually to room temperature. GC-MS analysis after 4 h indicated full conversion to the secondary amine. The reaction mixture was neutralized with aq. Na₂CO₃, extracted with EtOAc, washed with brine, dried with MgSO₄, filtered and concentrated under reduced pressure. The crude product was purified by flash column chromatography (0-15% EtOAc in hexanes) to give the secondary amine product (177 mg, 68%). ¹H NMR (499 MHz, CDCl₃) δ 7.07 (d, J=8.3, 2H), 6.61 (d, J=8.4, 2H), 3.51 (dd, J=6.1, 12.3, 1H), 3.27 (s, 1H), 2.60 (m, 2H), 1.65 (m, 4H), 1.45 (m, 11H), 1.25 (d, J=6.3, 4H), 1.01 (dt, J=7.2, 14.4, 3H). ¹³C NMR (126 MHz, CDCl₃) δ 145.94, 131.48, 129.38, 113.45, 49.03, 37.62, 34.99, 34.31, 32.14, 29.68, 26.45, 22.92, 22.64, 21.14, 14.36, 14.27.

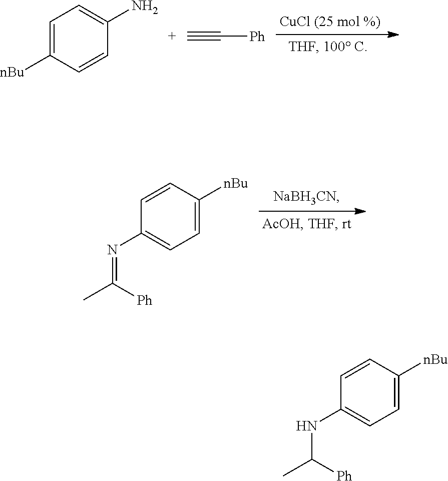

One-Pot Alkyne Hydroamination and Reduction with 4-n-Bu-aniline and Phenylacetylene.

Inside a glove box, CuCl (24.9 mg, 0.250 mmol, 0.250 equiv), 4-nBu-aniline (224 mg, 1.50 mmol, 1.50 equiv), phenylacetylene (102 mg, 1.00 mmol, 1.00 equiv), and dry THF (2 mL) were added to a dry vial containing a magnetic stir bar. The vial was sealed, removed from the glove box, and heated at 100° C. for 16 h. After heating, the reaction mixture was cooled to room temperature and analyzed by GC-MS. After full conversion of the alkyne was observed, NaBH₃CN (189 mg, 3.00 mmol, 3.00 equiv) and 2 mL THF were added to the reaction mixture. The reaction mixture was cooled to 0° C. with an ice bath. AcOH (0.6 mL, 10 mmol, 10 equiv) was added dropwise to the reaction mixture. The ice bath was removed, and the reaction was allowed to warm gradually to room temperature. GC-MS analysis after 4 h indicated full conversion to the secondary amine. The reaction mixture was neutralized with aq. Na₂CO₃, extracted with EtOAc, washed with brine, dried with MgSO₄, filtered and concentrated under reduced pressure. The crude product was purified by flash column chromatography (0-15% EtOAc in hexanes) to give the secondary amine product (138 mg, 55%). ¹H NMR (500 MHz, CDCl₃) δ 7.46 (d, J=7.1, 2H), 7.40 (t, J=7.6, 2H), 7.31 (t, J=7.3, 1H), 7.00 (d, J=8.4, 2H), 6.54 (d, J=8.4, 2H), 4.54 (q, J=6.7, 1H), 3.99 (s, 1H), 2.55 (m, 2H), 1.60 (m, 6H), 1.41 (dq, J=7.4, 14.8, 2H), 0.99 (t, J=7.3, 3H). ¹³C NMR (126 MHz, CDCl₃) δ 145.82, 145.55, 131.92, 129.28, 128.92, 127.14, 126.18, 113.59, 54.03, 35.02, 34.30, 25.43, 22.68, 14.34.

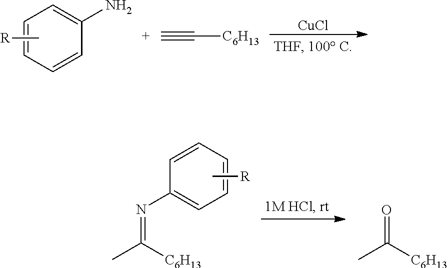

General Procedure for Copper-Catalyzed Alkyne Hydroamination.

Inside a glove box, CuCl (12.4 mg, 0.125 mmol, 0.250 equiv), an aromatic amine (0.75 mmol, 1.5 equiv), 1-octyne (56 mg, 0.50 mmol, 1.0 equiv), trimethoxybenzene, and dry THF (1 mL) were added to a dry vial containing a magnetic stir bar. The vial was sealed, removed from the glove box, and heated at 100° C. for 16-18 h. After heating, the reaction mixture was cooled to room temperature and analyzed by GC-MS. When full conversion of the alkyne was observed, 0.25 mL of 1 M HCl in H₂O was added to the reaction mixture and the mixture was stirred at room temperature for 4 h. After 4 h, the reaction mixture was analyzed by GC, and the yield of 2-octanone was determined by comparison to trimethoxybenzene, the internal standard, correcting for the response factor of the ketone to the standard.

TABLE 10
Masses of aromatic amines and yields for copper-catalyzed alkyne
hydroamination and hydrolysis.

| Aromatic Amine: | Mass of Aromatic | GC Yield of Ketone |
|---|---|---|
| R = | Amine (mg) | after Hydrolysis |
| 4-nBu | 112 | 77% |
| 4-OH | 82 | 80% |
| 4-CN | 89 | 51% |
| 4-CO₂Me | 114 | 68% |
| 3-Br | 129 | 84% |
| 4-acetyl | 102 | 60% |
| 2,6-di-isopropyl | 133 | 70% |

### Hydroarylation Examples

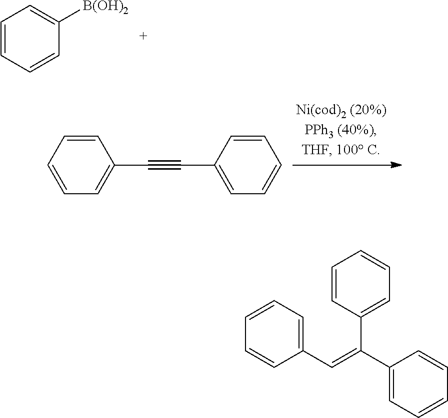

Nickel-Catalyzed Hydroarylation of Diphenylacetylene with Phenylboronic Acid.

Inside a glove box, Ni(cod)₂ (5.5 mg, 0.020 mmol, 0.20 equiv), PPh₃ (10.5 mg, 0.040 mmol, 0.40 equiv), diphenylacetylene (17.8 mg, 0.100 mmol, 1.00 equiv), phenylboronic acid (36.6 mg, 0.300 mmol, 3.00 equiv) and THF (0.4 mL) were added to a dry vial containing a magnetic stir bar. The vial was sealed, removed from the glove box, and heated at 100° C. for 18 h. After heating, the reaction mixture was cooled to room temperature and analyzed by GC. The yield of triphenylethylene was determined by comparison to 1,3,5-trimethoxybenzene, the internal standard.

General Hydroarylation Reaction with Boronic Acids.

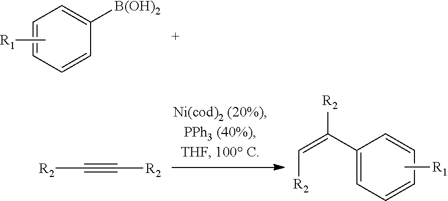

General Procedure for Nickel-Catalyzed Hydroarylation of Alkynes with Aryl or Heteroaryl Boronic Acids.

Inside a glove box, Ni(cod)₂ (16.5 mg, 0.06 mmol, 0.2 equiv), PPh₃ (31.5 mg, 0.12 mmol, 0.4 equiv), alkyne (0.300 mmol, 1.00 equiv), arylboronic acid or heteroarylboronic acid (0.900 mmol, 3.00 equiv) and THF (1.2 mL) were added to a dry vial containing a magnetic stir bar. The vial was sealed, removed from the glove box, and heated at 100° C. for 18 h. After heating, the reaction mixture was cooled to room temperature, filtered through silica gel washing with EtOAc, and concentrated under vacuum. The reaction mixture was then purified by column chromatography to give the product. The isomeric ratio (Z:E) was determined by comparison of GC peak areas.

Nickel-Catalyzed Hydroarylation of Diphenylacetylene with 4-(Trifluoromethyl)-Phenylboronic Acid.

Reaction performed according to the general procedure with 4-(trifluoromethyl)phenylboronic acid (171 mg) and diphenylacetylene (53.4 mg) to provide 88 mg of the product (91%) as a colorless oil. Column chromatography was performed with 5:95 ethyl acetate:hexanes. Z:E=8.3:1. ¹H NMR (499 MHz, CDCl₃) δ 7.62 (d, J=8.3, 2H), 7.35 (m, 7H), 7.20 (m, 4H), 7.06 (m, 2H). ¹³C NMR (126 MHz, CDCl₃) δ 144.54, 142.94, 141.49, 137.07, 131.17, 130.49, 129.79, 129.64, 129.12, 128.94, 128.65, 128.43, 128.12, 127.89, 127.43, 126.77, 125.82, 125.79.

Nickel-Catalyzed Hydroarylation of Diphenylacetylene with 4-Formylphenylboronic Acid.

The reaction was performed according to the general procedure with 4-formylphenyl-boronic acid (135 mg) and diphenylacetylene (53.4 mg) to provide the 65 mg of the product (76%) as a colorless oil. Column chromatography was performed with 5:95 ethyl acetate:hexanes. Z:E=11.8:1. ¹H NMR (500 MHz, CDCl₃) δ 10.04 (s, 1H), 7.85 (d, J=8.1, 2H), 7.40 (d, J=8.0, 2H), 7.31 (dt, J=14.0, 22.6, 4H), 7.16 (dd, J=5.9, 10.4, 4H), 7.04 (m, 3H). ¹³C NMR (126 MHz, CDCl₃) δ 192.22, 147.50, 142.81, 141.69, 136.98, 135.58, 131.54, 130.51, 130.26, 129.84, 129.80, 129.17, 128.66, 128.41, 128.15, 127.91, 127.49.

Nickel-Catalyzed Hydroarylation of Diphenylacetylene with 4-Cyanophenylboronic acid.

The reaction was performed according to the general procedure with 4-cyanophenylboronic acid (135 mg) and diphenylacetylene (53.4 mg) to provide 52 mg of the product (62%) as a yellow solid. Column chromatography was performed with 10:90 ethyl acetate:hexanes. Z:E=>20:1. ¹H NMR (499 MHz, CDCl₃) δ 7.62 (m, 2H), 7.34 (m, 4H), 7.27 (m, 2H), 7.18 (dt, J=3.1, 6.2, 4H), 7.04 (m, 3H). ¹³C NMR (126 MHz, CDCl₃) δ 145.83, 142.51, 141.16, 136.75, 132.61, 131.66, 130.16, 129.76, 128.72, 128.49, 128.28, 127.90, 127.63, 119.12, 111.40.

Nickel-Catalyzed Hydroarylation of Diphenylacetylene with 4-Acetylphenylboronic Acid.

The reaction was performed according to the general procedure with 4-acetylphenylboronic acid (148 mg) and diphenylacetylene (53.4 mg) to provide 65 mg of the product (73%) as a white solid. Column chromatography was performed with 10:90 ethyl acetate:hexanes. Z:E=3.6:1. ¹H NMR (500 MHz, CDCl₃) δ 7.93 (d, J=8.2, 2H), 7.32 (m, 6H), 7.16 (dd, J=5.0, 9.5, 2H), 7.05 (m, 5H), 2.63 (s, 3H). ¹³C NMR (126 MHz, CDCl₃) δ 198.08, 145.97, 142.97, 141.86, 137.09, 136.27, 131.04, 129.78, 129.51, 128.90, 128.59, 128.37, 128.05, 127.87, 127.36, 26.79.

Nickel-Catalyzed Hydroarylation of Diphenylacetylene with 4-Methoxycarbonyl-Phenylboronic Acid.

The reaction was performed according to the general procedure with 4-methoxycarbonylphenylboronic acid (162 mg) and diphenylacetylene (53.4 mg) to provide 85 mg of the product (90%) as a white solid. Column chromatography was performed with 10:90 ethyl acetate:hexanes. Z:E=3.2:1. ¹H NMR (500 MHz, CDCl₃) δ 8.02 (m, 3H), 7.37 (m, 6H), 7.19 (m, 3H), 7.06 (m, 3H), 3.95 (s, 3H). ¹³C NMR (126 MHz, CDCl₃) δ 167.31, 145.79, 142.99, 137.11, 133.17, 132.10, 130.86, 130.16, 129.94, 129.08, 128.59, 128.04, 127.87, 127.35, 115.49, 52.39.

Nickel-Catalyzed Hydroarylation of Diphenylacetylene with 4-Chlorophenylboronic Acid.

The reaction was performed according to the general procedure with 4-chlorophenyl-boronic acid (141 mg) and diphenylacetylene (53.4 mg) to provide 72 mg of the product (83%) as a white solid. Column chromatography was performed with 5:95 ethyl acetate:hexanes. Z:E=11.3:1. ¹H NMR (500 MHz, CDCl₃) δ 7.53 (m, 1H), 7.32 (m, 5H), 7.16 (m, 5H), 7.04 (m, 3H), 6.98 (s, 1H). ¹³C NMR (126 MHz, CDCl₃) δ 143.29, 141.59, 139.04, 137.27, 132.21, 129.75, 129.12, 128.99, 128.54, 128.35, 127.96, 127.87, 127.22, 126.75.

Nickel-Catalyzed Hydroarylation of Diphenylacetylene with Benzofuran-2-Boronic Acid.

The reaction was performed according to the general procedure with benzofuran-2-boronic acid (146 mg) and diphenylacetylene (53.4 mg) to provide 84 mg of the product (95%) as a white solid. Column chromatography was performed with 5:95 ethyl acetate:hexanes. Z:E=>20:1. ¹H NMR (500 MHz, CDCl₃) δ 7.57 (dd, J=9.0, 17.1, 2H), 7.48 (m, 3H), 7.42 (m, 2H), 7.33 (m, 2H), 7.29 (m, 2H), 7.22 (t, J=7.4, 1H), 7.18 (m, 2H), 7.09 (dd, J=6.7, 12.0, 1H), 6.27 (s, 1H). ¹³C NMR (126 MHz, CDCl₃) δ 158.18, 155.27, 137.76, 136.48, 132.75, 131.76, 130.26, 129.99, 129.22, 128.35, 128.32, 127.58, 127.56, 124.96, 123.10, 121.17, 111.19, 106.41.

Nickel-Catalyzed Hydroarylation of Diphenylacetylene with Thiophene-2-Boronic acid.

The reaction was performed according to the general procedure with thiophene-2-boronic acid (116 mg) and diphenylacetylene (53.4 mg) to provide 70 mg of the product (89%) as a colorless oil. Column chromatography was performed with 5:95 ethyl acetate:hexanes. Z:E=2.9:1. ¹H NMR (499 MHz, CDCl₃) δ 7.47 (m, 1H), 7.44 (m, 2H), 7.37 (m, 2H), 7.26 (m, 2H), 7.16 (m, 3H), 7.03 (dd, J=2.2, 5.7, 1H), 6.99 (dd, J=3.7, 5.0, 1H), 6.95 (dd, J=0.8, 3.4, 1H), 6.79 (d, J=3.5, 1H). ¹³C NMR (126 MHz, CDCl₃) δ 148.22, 139.72, 136.91, 130.73, 129.72, 129.08, 128.49, 128.28, 128.12, 127.75, 127.11, 126.63, 126.38, 125.01.

Nickel-Catalyzed Hydroarylation of 3-Hexyne with Benzofuran-2-Boronic Acid.

The reaction was performed according to the general procedure with benzofuran-2-boronic acid (146 mg) and 3-hexyne (24.7 mg) to provide 33 mg of the product (55%) as a colorless oil. Column chromatography was performed with 5:95 ethyl acetate:hexanes. Z:E=3.7:1. ¹H NMR (499 MHz, CDCl₃) δ 7.53 (d, J=7.6, 1H), 7.45 (d, J=8.1, 1H), 7.22 (m, 2H), 6.59 (s, 1H), 5.66 (t, J=7.1, 1H), 2.49 (dd, J=7.6, 15.2, 2H), 2.31 (m, 2H), 1.15 (m, 6H). ¹³C NMR (126 MHz, CDCl₃) δ 157.66, 154.77, 133.52, 130.89, 129.58, 124.02, 122.74, 120.72, 110.94, 101.07, 21.50, 21.47, 14.52, 14.47.

Hydroarylation Reactions with Halides.

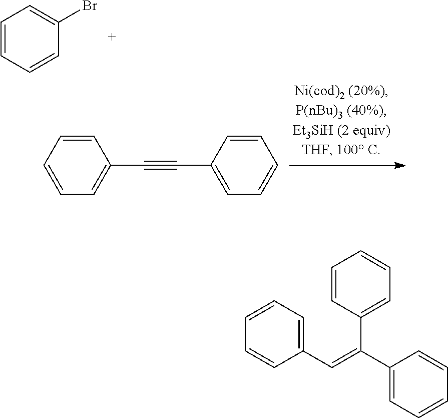

Nickel-Catalyzed Hydroarylation of Diphenylacetylene with Bromobenzene.

Inside a glove box, Ni(cod)₂ (5.5 mg, 0.020 mmol, 0.20 equiv), P(nBu)₃ (8.1 mg, 0.040 mmol, 0.40 equiv), diphenylacetylene (35.6 mg, 0.200 mmol, 2.00 equiv), bromobenzene (15.7 mg, 0.100 mmol, 1.00 equiv), triethylsilane (24 mg, 0.20 mmol, 2.0 equiv) and THF (0.2 mL) were added to a dry vial containing a magnetic stir bar. The vial was sealed, removed from the glove box, and heated at 100° C. for 18 h. After heating, the reaction mixture was cooled to room temperature and analyzed by GC. The yield of triphenylethylene was determined by comparison to 1,3,5-trimethoxybenzene, the internal standard.

General Hydroarylation Reaction with Halides.

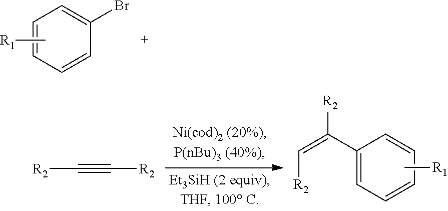

General Procedure for Nickel-Catalyzed Hydroarylation of Diphenylacetylene with Aryl or Heteroaryl Bromides.

Inside a glove box, Ni(cod)₂ (16.5 mg, 0.06 mmol, 0.2 equiv), P(nBu)₃ (24.3 mg, 0.12 mmol, 0.4 equiv), diphenylacetylene (107 mg, 0.600 mmol, 2.00 equiv), arylbromide or heteroarylbromide (0.300 mmol, 3.00 equiv), triethylsilane (70 mg, 0.60 mmol, 2.0 equiv) and THF (0.6 mL) were added to a dry vial containing a magnetic stir bar. The vial was sealed, removed from the glove box, and heated at 100° C. for 18 h. After heating, the reaction mixture was cooled to room temperature, filtered through silica gel washing with EtOAc, and concentrated under vacuum. The reaction mixture was purified by column chromatography to give the product. The isomeric ratio (Z:E) was determined by comparison of GC peak areas.

Nickel-Catalyzed Hydroarylation of Diphenylacetylene with 2-Bromotoluene.

Reaction performed according to the general procedure with 2-bromotoluene (51.3 mg) to provide 44 mg of the product (54%) as a yellow oil. Column chromatography was performed with 5:95 ethyl acetate:hexanes. Z:E=17.5:1. ¹H NMR (500 MHz, CDCl₃) δ 7.36 (m, 2H), 7.33 (m, 2H), 7.29 (m, 2H), 7.24 (m, 2H), 7.15 (m, 2H), 7.11 (s, 1H), 6.99 (dd, J=1.6, 7.8, 2H), 2.08 (s, 3H). ¹³C NMR (126 MHz, CDCl₃) δ 142.56, 141.62, 139.90, 137.57, 136.87, 130.78, 130.43, 129.27, 128.94, 128.48, 128.35, 127.93, 127.63, 127.15, 126.84, 126.63, 19.92.

Nickel-Catalyzed Hydroarylation of Diphenylacetylene with Methyl 2-Bromobenzoate.

Reaction performed according to the general procedure with methyl 2-bromobenzoate (64.5 mg) to provide 50 mg of the product (53%) as a yellow oil. Column chromatography was performed with 10:90 ethyl acetate:hexanes. Z:E=4.2:1. ¹H NMR (499 MHz, CDCl₃) δ 7.98 (d, J=7.6, 1H), 7.65 (m, 1H), 7.44 (m, 3H), 7.25 (m, 5H), 7.12 (m, 3H), 6.98 (m, 2H), 3.58 (s, 3H). ¹³C NMR (126 MHz, CDCl₃) δ 167.70, 143.07, 142.61, 141.62, 137.51, 132.54, 132.48, 131.03, 130.22, 129.59, 128.43, 128.24, 127.88, 127.83, 127.57, 127.04, 126.96, 52.08.

Nickel-Catalyzed Hydroarylation of Diphenylacetylene with 5-Bromobenzofuran.

Reaction performed according to the general procedure with 5-bromobenzofuran (59.1 mg) to provide 61 mg of the product (69%) as a colorless oil. Column chromatography was performed with 10:90 ethyl acetate:hexanes. Z:E=1.1:1. ¹H NMR (499 MHz, CDCl₃) δ 7.65 (m, 1H), 7.56 (d, J=1.6, 1H), 7.49 (m, 2H), 7.36 (m, 5H), 7.28 (m, 3H), 7.08 (m, 2H), 7.04 (s, 1H), 6.74 (d, J=8.0, 1H). ¹³C NMR (126 MHz, CDCl₃) δ 154.87, 145.74, 143.13, 141.08, 137.82, 135.25, 130.72, 129.75, 128.88, 128.24, 127.94, 127.19, 126.85, 124.67, 123.24, 120.75, 111.89, 107.06.

Nickel-Catalyzed Hydroarylation of Diphenylacetylene with 2-Bromothiophene.

Reaction performed according to the general procedure with 2-bromothiophene (49.0 mg) to provide 30 mg of the product (38%) as a colorless oil. Column chromatography was performed with 5:95 ethyl acetate:hexanes. Z:E=5.4:1. ¹H NMR (499 MHz, CDCl₃) δ 7.55 (d, J=7.3, 1H), 7.41 (m, 3H), 7.31 (m, 3H), 7.22 (m, 2H), 7.12 (m, 2H), 6.98 (m, 2H), 6.75 (d, J=3.6, 1H). ¹³C NMR (126 MHz, CDCl₃) δ 148.18, 139.67, 137.56, 136.86, 136.50, 130.14, 129.67, 129.03, 128.93, 128.23, 127.86, 126.75, 126.58, 124.96.

### Determination of Olefin Stereochemistry.

Assignment of E Alkene Product:

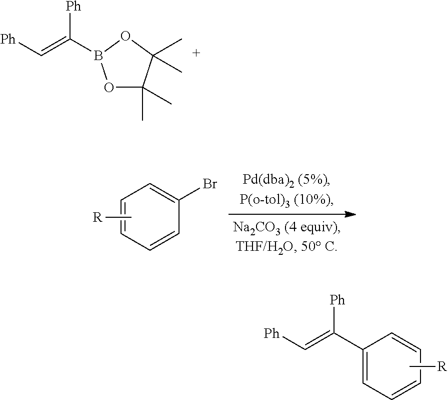

Inside a glove box, Pd(dba)₂ (1.4 mg, 0.0025 mmol, 0.050 equiv), P(o-tol)₃ (1.5 mg, 0.0050 mmol, 0.050 equiv), cis-stilbeneboronic acid pinacol ester (15.3 mg, 0.0500 mmol, 1.00 equiv), aryl bromide (11.3 mg, 0.0500 mmol, 1.00 equiv), sodium carbonate (22 mg, 0.20 mmol, 4.0 equiv), THF (0.2 mL) and degassed H₂O (0.04 mL) were added to a dry vial containing a magnetic stir bar. The vial was sealed, removed from the glove box, and heated at 50° C. for 18 h. After heating, the reaction mixture was cooled to room temperature and analyzed by GC-MS. The GC-MS retention times of the product from this Suzuki-Miyaura coupling reaction, which is the E alkene product, and the products from the alkyne hydroarylation were then compared. The GC-MS retention time of the triarylalkene product observed from this Suzuki-Miyaura coupling matched the minor product of the alkyne hydroarylation reactions. Therefore, the minor product of the hydroarylation was assigned as the E alkene product.

### Assignment of Z Alkene Product:

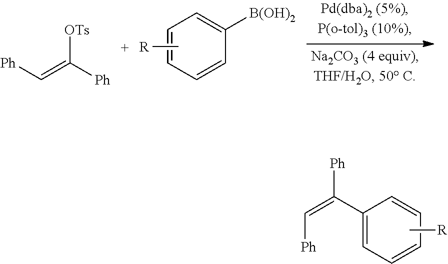

Inside a glove box, Pd(dba)₂ (1.4 mg, 0.0025 mmol, 0.050 equiv), P(o-tol)₃ (1.5 mg, 0.0050 mmol, 0.050 equiv), Z-1,2-diphenylethenyl tosylate (17.5 mg, 0.0500 mmol, 1.00 equiv), aryl boronic acid (0.0750 mmol, 1.50 equiv), sodium carbonate (22 mg, 0.20 mmol, 4.0 equiv), THF (0.2 mL) and degassed H₂O (0.04 mL) were added to a dry vial containing a magnetic stir bar. The vial was sealed, removed from the glove box, and heated at 50° C. for 18 h. After heating, the reaction mixture was cooled to room temperature and analyzed by GC-MS. The GC-MS retention times of the product from this Suzuki-Miyaura coupling reaction, which is the Z alkene product, and the products from the alkyne hydroarylation were then compared. The GC-MS retention time of the triarylalkene product observed from this Suzuki-Miyaura coupling matched the major product of the alkyne hydroarylation reactions. Therefore, the major product of the hydroarylation was assigned as the Z alkene product.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A method comprising heating a test mixture to potentially initiate a metal-mediated conjugation reaction;
wherein the test mixture initially comprises a combination of seven or more reaction mixtures and optionally one or more control mixtures; and
wherein each reaction mixture comprises a metal catalyst precursor, a ligand, and a diverse mixture of substrates, prior to heating or reaction initiation; and
analyzing the test mixture for the presence of a conjugation product, wherein the mass of any conjugation product formed from a metal-mediated conjugation reaction exceeds the mass of any single substrate of the reaction mixtures by at least about 50%; thereby identifying a successful metal-mediated conjugation reaction by the presence of a conjugation product, wherein the presence of a conjugation product in the test mixture confirms that a metal-mediated conjugation reaction occurred in one or more of the reaction mixtures.

2. The method of claim 1 wherein at least one conjugation product is present in the test mixture.

3. The method of claim 1 wherein the metal catalyst precursor comprises a transition metal, a lanthanide, or an actinide.

4. The method of claim 3 wherein the diverse mixture of substrates comprises four or more different substrates in each reaction mixture.

5. The method of claim 4 wherein the diverse mixture of substrates comprises about 8 to about 24 different substrates.

6. The method of claim 5 wherein the diverse mixture of substrates includes organic compounds comprising 7-20 heavy atoms selected from C, N, O, P, S, and F.

7. The method of claim 6 wherein the diverse mixture of substrates includes organic compounds having molecular masses of about 100 Da to about 500 Da.

8. The method of claim 1 wherein analyzing the test mixture for the presence of the conjugation product comprises the use of liquid chromatograph, gas chromatography, mass spectrometry, or a combination thereof.

9. The method of claim 1 wherein each reaction mixture includes only one metal catalyst precursor and the seven or more reaction mixtures comprise three or more different metal catalyst precursors.

10. The method of claim 1 wherein each reaction mixture includes only one ligand and the seven or more reaction mixtures comprise three or more different ligands.

11. The method of claim 1 wherein the test mixture comprises a combination of about 12 to about 144 reaction mixtures.

12. The method of claim 1 wherein the conjugation reaction is catalytic with respect to the metal of the metal catalyst precursor.

13. The method of claim 1 wherein the reaction mixtures are arranged in an x-y array of reaction vessels and the x-y array comprises a plurality of metal catalyst precursors, a plurality of ligands, or both.

14. The method of claim 1 wherein a reaction mixture further comprises a solvent.

15. The method of claim 14 wherein a reaction mixture further comprises one or more additives, wherein the additive is one or more of an oxidant, a reductant, an acid, a base, carbon monoxide (CO), or carbon dioxide (CO₂).

16. The method of claim 1 comprising measuring the masses of non-polar products by gas chromatography/mass spectrometry (GC/MS), measuring the masses of polar products by electrospray ionization mass spectrometry (ESI-MS), or a combination thereof.

17. A method comprising preparing a compound of Formula I: 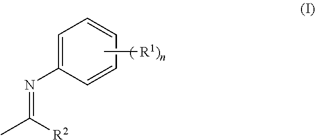
wherein
R¹ is —H, —OH, —(C₁-C₂₄)alkyl, —(C₁-C₂₄)alkoxy, (C₁-C₂₄)acyl, (C₁-C₂₄)alkoxycarbonyl, (C₁-C₂₄)acyloxy, —CF₃, —NO₂, —CN, —CHO, or halo;
n is 1, 2, 3, 4, or 5; and
R² is (C₁-C₂₄)alkyl, aryl, heteroaryl, heterocycle or —SiR′₃ where each R′ is independently alkyl, aryl, alkoxy, or aryloxy;
comprising contacting a compound of Formula II: 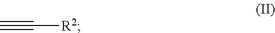
wherein R² is as defined above for Formula I;
and a compound of Formula III: 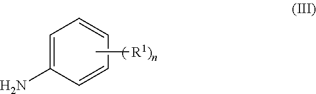
wherein R¹ is as defined above for Formula I;
in the presence of CuCl or Cu(OAc)₂, to provide a reaction mixture, and
heating the reaction mixture above 25° C., to provide the compound of Formula I.

18. The method of claim 17 comprising heating the compounds of Formula II and III to a temperature of about 50° C. to about 150° C.

19. The method of claim 18 further comprising reducing the imine of Formula Ito an amine.

20. The method of claim 17 wherein the reaction mixture further comprises a ligand selected from PBu₃, a β-diketiminate (nacnac-type) ligand, and tri-p-tolylphosphite.

21. A method comprising preparing a compound of Formula V: 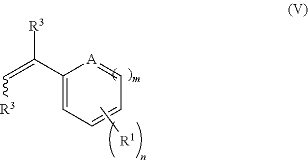
wherein
A is C, N, O, or S;
m is 1 when A is C, m is 0 when A is O or S, and m is 0 or 1 when A is N;
R¹ is —H, —OH, —(C₁-C₂₄)alkyl, —(C₁-C₂₄)alkoxy, (C₁-C₂₄)acyl, (C₁-C₂₄)alkoxycarbonyl, (C₁-C₂₄)acyloxy, —CF₃, —NO₂, —CN, —CHO, or halo; or two R¹ groups together form a fused benzo, furan, or thiophene ring on the ring of Formula V;
n is 1, 2, 3, 4, or 5; and
each R³ is independently H, —(C₁-C₂₄)alkyl, aryl, heteroaryl, heterocycle, or —SiR′₃ where each R′ is independently alkyl, aryl, alkoxy, or aryloxy, provided that both R³ groups are not H;
comprising contacting a compound of Formula VI: 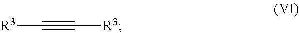
wherein R³ is as defined above for Formula V, provided that the compound of Formula VI is a liquid or solid at 23° C.;
and a compound of Formula VII: 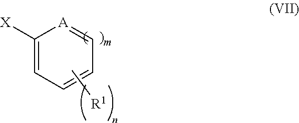
wherein
A, m, and R¹ are as defined above for Formula V; and
X is B(OH)₂, Br, or I;
in the presence of Ni(cod)₂ or NiCl₂-dme, and a phosphine ligand or SIPr (1,3-bis(2,6-diisopropylphenyl)-4,5-dihydro-1H-imidazol-3-ium), to provide a reaction mixture; and
heating the reaction mixture above 25° C., to provide the compound of Formula V.

22. The method of claim 21 wherein the compound of Formula VI is diphenylacetylene and each phenyl is optionally substituted with one or two R³ groups.

23. The method of claim 21 wherein X is B(OH)₂, the ligand is PPh₃, and the ratio of the anti-addition product to the syn-addition product of the compound of Formula V is at least a 3:1 ratio.

24. The method of claim 21 wherein X is Br or I, the ligand is P(nBu)₃, and the ratio of the anti-addition product to the syn-addition product of the compound of Formula V is at least a 3:1 ratio.
